(19) United States
(12) Patent Application Publication
(10) Pub. No.: US 2025/0013994 A1
(43) Pub. Date: Jan. 9, 2025

(54) VIRTUAL CHESS PIECE SELLING METHOD APPARATUS, AND MEDIUM

(71) Applicant: Tencent Technology (Shenzhen) Company Limited, Shenzhen (CN)

(72) Inventor: Yanan Zhang, Shenzhen (CN)

(21) Appl. No.: 18/890,228

(22) Filed: Sep. 19, 2024

Related U.S. Application Data
(63) Continuation of application No. PCT/CN2023/123244, filed on Oct. 7, 2023.

(30) Foreign Application Priority Data
Nov. 15, 2022 (CN) 2022114290377

(51) Int. Cl. G06Q 20/06; A63F 3/02; A63F 13/822; G06Q 30/0207

(52) U.S. Cl. CPC G06Q 20/06; A63F 3/02; A63F 13/822; G06Q 30/0209

(57) ABSTRACT

A virtual chess piece selling method, apparatus, and a medium are provided. The method includes: during a turn-based chess game, displaying, in response to a purchase operation on a virtual chess piece, a quantity of consumed resources when the virtual chess piece is purchased; the quantity of consumed resources corresponding to a quantity of discount resources; displaying, in response to a selling operation on the virtual chess piece owned, selling information of the virtual chess piece, the selling information indicating a quantity of new resources after the virtual chess piece is successfully sold, and a quantity of discount resources corresponding to the quantity of new resources being the same as the quantity of discount resources corresponding to the quantity of consumed resources; and displaying that the virtual chess piece is successfully sold in a case that the virtual chess piece is in a non-battle state.

### RELATED APPLICATION

This application is a continuation application of PCT Application PCT/CN2023/123244, filed on Oct. 7, 2023, which claims priority to Chinese Patent Application No. 202211429037.7, filed on Nov. 15, 2022, each entitled “VIRTUAL CHESS PIECE SELLING METHOD AND APPARATUS, DEVICE, MEDIUM, AND PROGRAM PRODUCT”, and each of which is incorporated herein by reference in its entirety.

### FIELD

This application is related to the field of virtual environments, and in particular to a virtual chess piece selling method and apparatus, a device, a medium, and a program product.

### BACKGROUND

An autochess game is a turn-based chess game in which virtual chess pieces (generally referred to as “chess pieces”) need to be selected by a player from newly purchased virtual chess pieces or from owned virtual chess pieces, and then automatically play against an opponent virtual chess piece lineup.

In the related art, the player may purchase virtual chess pieces from a store to improve basic levels and skill effects of the owned virtual chess pieces. The player may also sell a virtual chess piece to obtain a corresponding quantity of gold coins. Different virtual chess pieces correspond to different quantities of gold coins when purchased and sold, and a same type of virtual chess pieces correspond to different quantities of gold coins when purchased and sold.

However, a device in the related art needs to store a corresponding relationship between a large number of virtual chess pieces and quantities of gold coins at the time of purchase and selling, which occupies large storage space.

### SUMMARY

This application provides a virtual chess piece selling method and apparatus, a device, a medium, and a program product. The technical solutions are as follows:

According to one aspect of this application, a virtual chess piece selling method is provided. The method is performed by a computing device and includes:
during a turn-based chess game, displaying, in response to a purchase operation on a virtual chess piece, a quantity of consumed resources based on the virtual chess piece being purchased, the quantity of consumed resources corresponding to a quantity of discount resources;
displaying, in response to a selling operation on the virtual chess piece, selling information of the virtual chess piece, the selling information indicating a quantity of new resources based on the virtual chess piece being successfully sold, and a quantity of discount resources corresponding to the quantity of new resources being the same as the quantity of discount resources corresponding to the quantity of consumed resources; and
displaying that the virtual chess piece is successfully sold based on the virtual chess piece being in a non-battle state.

According to another aspect of this application, a virtual chess piece selling apparatus is provided, including one or more processors and memory storing instructions, when executed by the one or more processors, cause the apparatus to perform the methods described herein. The virtual chess piece selling apparatus may include:
a display module configured to, during a turn-based chess game, display, in response to a purchase operation on a virtual chess piece, a quantity of consumed resources based on the virtual chess piece being purchased; the quantity of consumed resources corresponding to a quantity of discount resources;
the display module being configured to display, in response to a selling operation on the virtual chess piece, selling information of the virtual chess piece, the selling information indicating a quantity of new resources based on the virtual chess piece being successfully sold, and a quantity of discount resources corresponding to the quantity of new resources being the same as the quantity of discount resources corresponding to the quantity of consumed resources; and
the display module being configured to display that the virtual chess piece is successfully sold based on the virtual chess piece being in a non-battle state.

According to another aspect of this application, a computer device is provided, including: a processor and a memory, the memory storing a computer program, the computer program being loaded and executed by the processor to implement the virtual chess piece selling method as described herein.

According to another aspect of this application, a non-transitory computer-readable storage medium is provided, storing a computer program, the computer program being loaded and executed by a processor to implement the virtual chess piece selling method as described herein.

According to another aspect of this application, a computer program product is provided, including computer instructions, the computer instructions being stored in a computer-readable storage medium, and a processor acquiring the computer instructions from the computer-readable storage medium, so that the processor loads and executes the computer instructions to implement the virtual chess piece selling method as described herein.

The technical solutions provided in the examples of this application have at least the following beneficial effects:

By use of the method provided in the examples of this application, the computer device does not need to store quantities of virtual resources respectively corresponding to a large number of virtual chess pieces at the time of purchase and selling. Moreover, in the examples of this application, the quantities of virtual resources between purchase and selling of the virtual chess pieces are correlated. When a quantity of discount resources when a virtual chess piece is purchased is determined, a quantity of discount resources when the virtual chess piece is sold may be determined, without occupying excessive storage space of the computer device. For example, the quantity of discount resources when the virtual chess piece is purchased is 2 gold coins. To be specific, 2 gold coins are saved when the virtual chess piece is purchased. Then, the corresponding quantity of discount resources when the virtual chess piece is sold is also 2 gold coins. To be specific, when the virtual chess piece is sold, 2 gold coins are deducted from a number of gold coins at the time of original selling. The computer device may determine, only by storing the number of gold coins at the time of original selling corresponding to the virtual chess piece and according to a number of gold coins saved at the time of purchase, a number of gold coins at the time of actual selling obtained when the virtual chess piece is sold. The number of gold coins at the time of actual selling is the number of gold coins at the time of original selling minus the number of gold coins saved at the time of purchase. Through the solution, the computer device achieves an effect of saving the storage space of the computer device without storing numbers of gold coins at the time of actual selling respectively corresponding to the virtual chess piece in various purchase situations.

### BRIEF DESCRIPTION OF THE DRAWINGS

FIG. 1 is a structural block diagram of a computer system according to an example.

FIG. 2 is a schematic diagram of a related technology according to an example.

FIG. 3 is a schematic diagram of a related technology according to an example.

FIG. 4 is a schematic diagram of a related technology according to an example.

FIG. 5 is a schematic diagram of a related technology according to an example.

FIG. 6 is a flowchart of a virtual chess piece selling method according to an example.

FIG. 7 is a flowchart of a virtual chess piece selling method according to an example.

FIG. 8 is a flowchart of a virtual chess piece selling method according to an example.

FIG. 9 is a flowchart of a virtual chess piece selling method according to an example.

FIG. 10 is a flowchart of a virtual chess piece selling method according to an example.

FIG. 11 is a flowchart of a virtual chess piece selling method according to an example.

FIG. 12 is a flowchart of a virtual chess piece selling method according to an example.

FIG. 13 is a flowchart of a virtual chess piece selling method according to an example.

FIG. 14 is a schematic diagram of an interface for purchasing a virtual chess piece according to an example.

FIG. 15 is a schematic diagram of an interface for selling a virtual chess piece according to an example.

FIG. 16 is a schematic diagram of an interface for successfully selling a virtual chess piece according to an example.

FIG. 17 is a schematic diagram of an interface for selling a virtual chess piece according to an example.

FIG. 18 is a schematic diagram of an interface for successfully selling a virtual chess piece according to an example.

FIG. 19 is a schematic diagram of an interface for purchasing a virtual chess piece according to an example.

FIG. 20 is a schematic diagram of an interface for successfully selling a virtual chess piece according to an example.

FIG. 21 is a schematic diagram of an interface for successfully selling a virtual chess piece according to an example.

FIG. 22 is a schematic diagram of an interface for an upgrade reward according to an example.

FIG. 23 is a schematic diagram of an interface for talent information according to an example.

FIG. 24 is a schematic diagram of an interface for a virtual skill according to an example.

FIG. 25 is a schematic diagram of an interface for a gain type according to an example.

FIG. 26 is a schematic diagram of an interface for purchasing a virtual chess piece according to an example.

FIG. 27 is a schematic diagram of an interface for successfully selling a virtual chess piece according to an example.

FIG. 28 is a flowchart of a virtual chess piece selling method according to an example.

FIG. 29 is a structural block diagram of a virtual chess piece selling apparatus according to an example.

FIG. 30 is a structural block diagram of a computer device according to an example.

### DESCRIPTION

First, terms involved in the examples of this application are briefly introduced.

Autochess: autochess is a general term for a type of electronic strategy turn-based chess and card games based on a basic game rule that players draw chess pieces, choose combinations between different types of chess pieces, and then arrange the chess pieces on respective chessboards, and finally, the system automatically play against other players' chess pieces until the player who still has chess pieces alive wins this round. A certain amount of blood may be deducted from a loser of each round, and the process is repeated multiple times until only one player out of multiple players survives.

Chessboard: chessboard refers to a region in a battle interface of an auto chess game and configured for preparing for a battle and performing the battle, which may be any one of a two-dimensional virtual chessboard, a 2.5-dimensional virtual chessboard, and a three-dimensional virtual chessboard, which is not limited in this application. The chessboard is divided into a battle region and a battle preparation region. The battle region includes a plurality of battle chess squares of a same size. The battle chess squares are configured for placing battle chess pieces for a battle during the battle. The preparation region includes a plurality of battle preparation chess squares. The battle preparation chess squares are configured for placing battle preparation chess pieces. The battle preparation chess pieces may not participate in the battle during the battle, but may be dragged and placed in the battle region in a preparation stage. A player may sell, play, and retain chess pieces in the battle preparation region. A capacity of the chess pieces in the battle preparation region has an upper limit.

For example, with regard to an arrangement manner of chess squares in the battle region, in a possible implementation, the battle region includes n (rows)×m (columns) of battle chess squares, where n is an integer multiple of 2, and two adjacent rows of chess squares are aligned, or two adjacent rows of chess squares are interlaced. In addition, the battle region is equally divided into two parts in rows, namely, an own battle region and an opponent battle region, and in the preparation stage, a user can place chess pieces only in the own battle region.

Virtual chess piece: virtual chess piece refers to a chess piece placed on the chessboard, including virtual chess pieces for battle and virtual chess pieces for battle preparation. The virtual chess pieces for battle are virtual chess pieces in the battle region. The virtual chess pieces for battle preparation are virtual chess pieces in the battle preparation region.

In some examples, in the battle region, when different virtual chess pieces have a same attribute and a quantity reaches a preset value (or referred to as fetter), a virtual chess piece for battle with the attribute or all the virtual chess pieces for battle in the battle region can obtain a gain effect corresponding to the attribute. For example, when the battle region includes 2 virtual chess pieces for battle with a warrior attribute at the same time, all the virtual chess pieces for battle obtain a defense bonus of 10%. When the battle region includes 4 virtual chess pieces for battle with a warrior attribute at the same time, all the virtual chess pieces for battle obtain a defense bonus of 20%. When the battle region includes 3 virtual chess pieces for battle with an elf attribute at the same time, all the virtual chess pieces for battle obtain an evasion probability bonus of 20%.

Gold coin: gold coin is a basic resource (virtual resource) used in a game to purchase chess pieces, upgrade, and refresh a store. In each round, a fixed interest of 10% of basic gold coins and current gold coins (the interest is no more than 5, and there is no interest when the gold coins are less than 10). In the case of consecutive wins or losses, extra gold coins may be obtained according to a number of consecutive wins (losses).

Attribute: According to different types of chess pieces, each type of chess pieces has different attributes, and different chess pieces may have a same attribute. An attribute includes at least one of a grade and a star level. The grade is an inherent attribute of the chess pieces and is fixed. The star level is a non-inherent attribute of the chess pieces. The chess pieces may improve own star levels by star ascension. After star ascension of the chess pieces, basic attributes and skill strength may be significantly improved. The highest star level of the chess pieces is 3 stars.

Grade: grade refers to an inherent attribute of the chess pieces. According to rarity and skills of the chess pieces, the chess pieces may be divided into 1, 2, 3, 4, and 5 grades, corresponding to different purchase prices in a game store, namely 1, 2, 3, 4, and 5 gold coins.

Star ascension: When there are 3 identical chess pieces (star levels and grades are identical) on the chessboard and in the battle preparation region, the chess pieces may automatically be synthesized into a higher-star-level chess piece, and a grade of the higher-star-level chess piece is unchanged. This process is referred to as star ascension. For example, when there are 3 identical 1-star 1-grade chess pieces, a 2-star 1-grade chess piece may be automatically obtained by star ascension. When there are 3 identical 2-star 1-grade chess pieces, a 3-star 1-grade chess piece may be automatically obtained by star ascension. The highest star level of the chess pieces is 3 stars, and a total of 9 1-star chess pieces are needed to obtain 1 3-star chess piece by star ascension. After star ascension of the chess pieces, basic attributes and skill strength may be significantly improved. The player may purchase 1-star chess pieces from the game store, but cannot directly purchase 2-star and 3-star chess pieces.

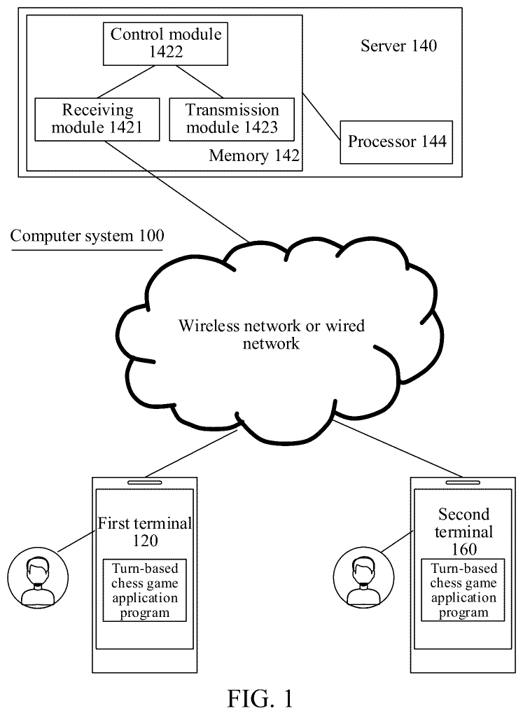

FIG. 1 is a structural block diagram of a computer system according to an example of this application. The computer system 100 includes: a first terminal 120, a server 140, and a second terminal 160.

A turn-based chess game application program, such as an autochess game application, is installed and run on the first terminal 120. The first terminal 120 is a terminal used by a first user. The first user uses the first terminal 120 to purchase new virtual chess pieces or sell owned virtual chess pieces in a battle preparation stage and/or a battle stage of a battle, or the first user uses the first terminal 120 to lay out virtual chess pieces for battle in a battle region of a chessboard in a preparation stage of the battle. The first terminal 120 automatically controls, according to attributes, skills, and layouts of the virtual chess pieces for battle in the battle region in the battle stage, the virtual chess pieces for battle to perform the battle.

The terminal 120 is connected to the server 140 by using a wireless network or a wired network.

The server 140 includes at least one of one server, a plurality of servers, a cloud computing platform, and a virtualization center. For example, the server 140 includes a processor 144 and a memory 142. The memory 142 includes a receiving module 1421, a control module 1422, and a transmission module 1423. The receiving module 1421 is configured to receive a request transmitted by a client, for example, a viewing request for viewing a lineup of opponent virtual chess pieces. The control module 1422 is configured to control rendering of a virtual environment picture. The transmission module 1423 is configured to transmit a response to the client, for example, transmit the lineup of opponent virtual chess pieces to the client. The server 140 is configured to provide a backend service for a turn-based chess game application program. In some examples, the server 140 takes on primary computing work, and the first terminal 120 and the second terminal 160 take on secondary computing work. Alternatively, the server 140 takes on the secondary computing work, and the first terminal 120 and the second terminal 160 take on the primary computing work. Alternatively, collaborative computing is performed among the server 140, the first terminal 120, and the second terminal 160 by using a distributed computing architecture.

A turn-based chess game application program, such as an autochess game application, is installed and run on the second terminal 160. The second terminal 160 is a terminal used by a second user. The second user uses the second terminal 160 to purchase new virtual chess pieces or sell owned virtual chess pieces in a battle preparation stage and/or a battle stage of a battle, or the second user uses the second terminal 160 to lay out virtual chess pieces for battle in a battle region of a chessboard in a preparation stage of the battle. The second terminal 160 automatically controls, according to attributes, skills, and layouts of the virtual chess pieces for battle in the battle region in the battle stage, the virtual chess pieces for battle to perform the battle.

In some examples, the virtual chess pieces for battle laid out by the first user and the second user respectively through the first terminal 120 and the second terminal 160 are located in different battle regions on a same chessboard. To be specific, the first user and the second user are in a same battle.

In some examples, the application programs installed on the first terminal 120 and the second terminal 160 are identical, or the application programs installed on the two terminals are a same type of application programs for different control system platforms. The first terminal 120 may generally refer to one of a plurality of terminals, and the second terminal 160 may generally refer to one of a plurality of terminals. In this example, the first terminal 120 and the second terminal 160 are described. Device types of the first terminal 120 and the second terminal 160 are the same or different. The device types include: at least one of a smartphone, a tablet computer, an e-book reader, a digital player, a laptop portable computer, and a desktop computer. In the following example, the terminal that includes a smartphone is described.

A person skilled in the art may learn that there may be more or fewer terminals. For example, there may be only one terminal (that is, a user battles against artificial intelligence (AI)), or there may be 8 terminals (1v1v1v1v1v1v1v1, 8 users battle to be eliminated cyclically, and finally a winner is determined) or more. The quantity and the device type of the terminal are not limited in this example of this application.

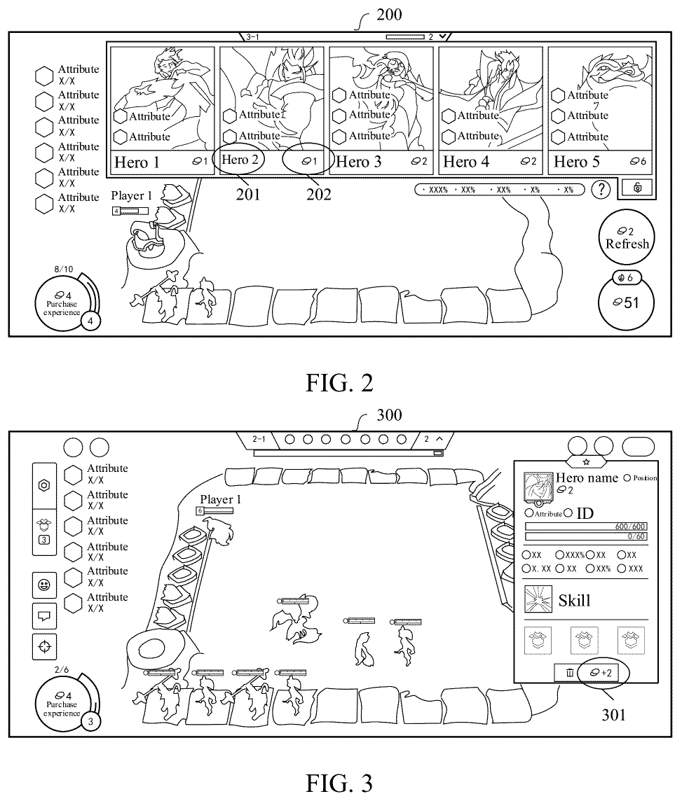

In some examples, refer to schematic diagrams of related technologies shown in FIG. 2, FIG. 3, and FIG. 4. As shown in FIG. 2, in a schematic diagram of a display interface 200 of a game store, a plurality of virtual chess pieces available for players to purchase are displayed, a name of a virtual chess piece is displayed in a display region 201, and a quantity of consumed resources required to purchase the virtual chess piece, that is, a quantity of gold coins spent, is displayed in a display region 202 to represent a purchase price. It costs 1 gold coin to purchase a 1-star 1-grade virtual chess piece, it costs 2 gold coins to purchase a 1-star 2-grade virtual chess piece, it costs 3 gold coins to purchase a 1-star 3-grade virtual chess piece, it costs 4 gold coins to purchase a 1-star 4-grade virtual chess piece, and it costs 5 gold coins to purchase a 1-star 5-grade virtual chess piece.

In the preparation stage or the battle stage, the player may sell owned virtual chess pieces. As shown in FIG. 3, in a schematic diagram of a display interface 300 in the battle stage, a quantity of new resources that the player may obtain by selling an owned virtual chess piece, that is, a quantity of gold coins that may be obtained, is displayed in a display region 301 to represent a selling price. When sold, a 1-star virtual chess piece is sold at an original purchase price. 1 gold coin may be obtained by selling the 1-star 1-grade virtual chess piece, 2 gold coins may be obtained by selling the 1-star 2-grade virtual chess piece, 3 gold coins may be obtained by selling the 1-star 3-grade virtual chess piece, 4 gold coins may be obtained by selling the 1-star 4-grade virtual chess piece, and 5 gold coins may be obtained by selling the 1-star 5-grade virtual chess piece. In FIG. 3, it is displayed in the display region 301 that the player may obtain 2 gold coins by selling the 1-star 2-grade virtual chess piece.

However, after star ascension of the virtual chess piece, the quantity of gold coins obtained by selling may be discounted. 3 gold coin may be obtained by selling a 2-star 1-grade virtual chess piece, 5 gold coins may be obtained by selling a 2-star 2-grade virtual chess piece, 8 gold coins may be obtained by selling a 2-star 3-grade virtual chess piece, 11 gold coins may be obtained by selling a 2-star 4-grade virtual chess piece, and 14 gold coins may be obtained by selling a 2-star 5-grade virtual chess piece. 8 gold coins may be obtained by selling a 3-star 1-grade virtual chess piece, 17 gold coins may be obtained by selling a 3-star 2-grade virtual chess piece, 28 gold coins may be obtained by selling a 3-star 3-grade virtual chess piece, 35 gold coins may be obtained by selling a 3-star 4-grade virtual chess piece, and 44 gold coins may be obtained by selling a 3-star 5-grade virtual chess piece. In FIG. 4, it is displayed in a display region 302 that the player may obtain 5 gold coins by selling the 2-star 2-grade virtual chess piece.

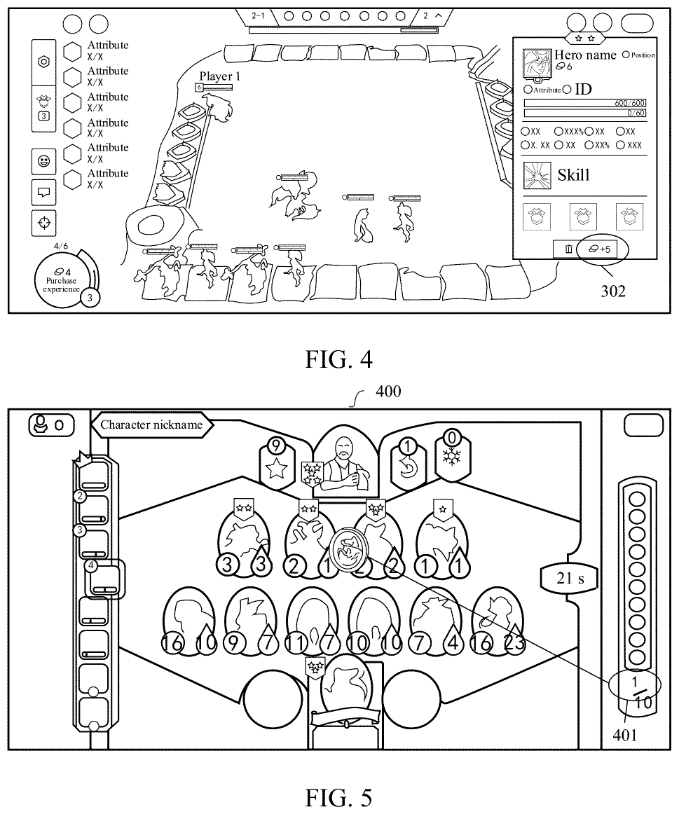

In some other examples, refer to a schematic diagram of a related technology shown in FIG. 5. As shown in FIG. 5, in a schematic diagram of a display interface 400, a plurality of virtual chess pieces owned by the player are displayed, and a quantity of gold coins that may be obtained by selling one virtual chess piece is displayed in a display region 401 to represent a selling price. It costs 3 gold coins to purchase a 1-star 1-grade, 1-star 2-grade, 1-star 3-grade, 1-star 4-grade, 1-star 5-grade, or 1-star 6-grade virtual chess piece. At the time of selling, regardless of start ascension of virtual chess pieces, 1 gold coin may be obtained by selling a 1-grade, 2-grade, 3-grade, 4-grade, 5-grade, or 6-grade virtual chess piece.

In the related technology, different virtual chess pieces correspond to different quantities of gold coins when purchased and sold, and a same type of virtual chess pieces correspond to different quantities of gold coins when purchased and sold. For example, selling prices of some virtual chess pieces may be discounted to some extent compared to purchase prices, while selling prices of some virtual chess pieces are the same as purchase prices. A computer device needs to store a corresponding relationship between a large number of virtual chess pieces and quantities of gold coins at the time of purchase and selling, which occupies large storage space.

With respect to the problems, an example of this application provides a virtual chess piece selling method, in which quantities of gold coins between purchase and selling of virtual chess pieces are correlated, without occupying excessive storage space. Further, the player may also easily understand and remember quantities of gold coins when virtual chess pieces are purchased and sold, which further helps the player adjust a game strategy.

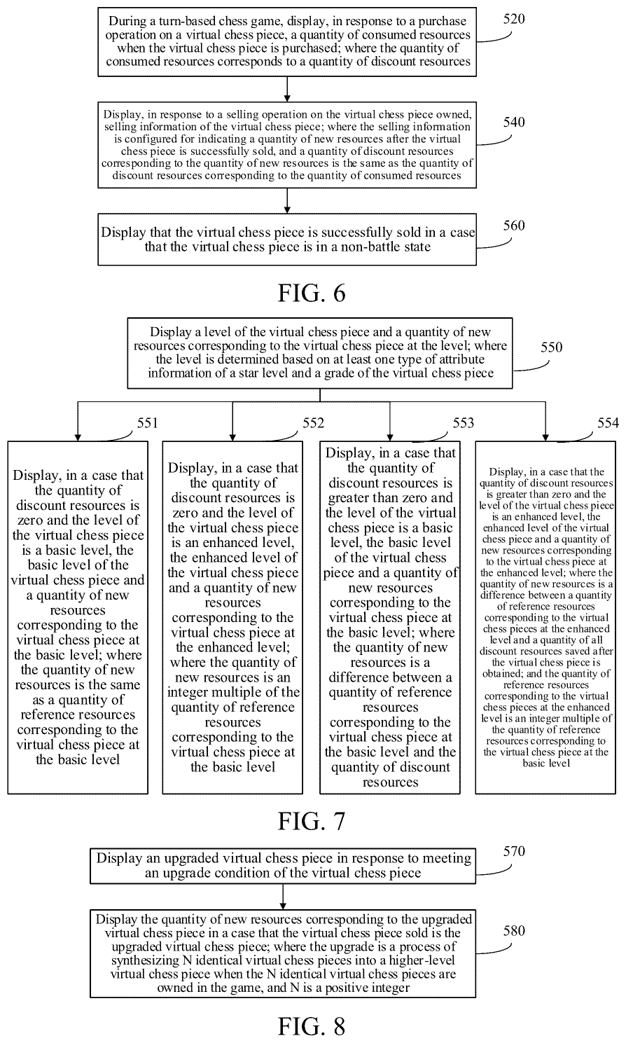

FIG. 6 is a flowchart of a virtual chess piece selling method according to an example of this application. The method is performed by a computer device. For example, the computer device may be the first terminal 120 or the second terminal 160 shown in FIG. 1. For example, the method is applied to the first terminal 120 shown in FIG. 1 or the turn-based chess game application program installed on the first terminal 120 or the second terminal 160 or the turn-based chess game application program installed on the second terminal 160. The method includes the following operations:

Operation 520: During a turn-based chess game, display, in response to a purchase operation on a virtual chess piece, a quantity of consumed resources when the virtual chess piece is purchased; the quantity of consumed resources corresponding to a quantity of discount resources.

The purchase operation is an operation in which the player purchases a virtual chess piece from the game store. The purchase operation may be a click operation on a virtual chess piece to be purchased.

The resources refer to virtual resources in the game. The resources include at least one of gold coins and virtual gold coins.

The quantity of consumed resources is a quantity of gold coins consumed (or spent) when the virtual chess piece is purchased. The quantity of consumed resources is configured for representing a purchase price of the virtual chess piece.

The quantity of discount resources corresponding to the quantity of consumed resources refers to a quantity of gold coins discounted (or saved) corresponding to the purchased virtual chess piece. The quantity of discount resources is configured for representing a discounted purchase price of the virtual chess piece. The discounted purchase price is less than or equal to a set original purchase price.

In some examples, the quantity of consumed resources is determined based on a quantity of reference resources of the virtual chess piece and the quantity of discount resources.

The quantity of reference resources of the virtual chess piece refers to a set original purchase price corresponding to the virtual chess piece at a basic level. At the basic level, an original selling price and an original purchase price of the virtual chess piece are the same.

For example, the quantity of consumed resources is a difference between the quantity of reference resources of the virtual chess piece and the quantity of discount resources. To be specific, the quantity of consumed resources=the quantity of reference resources−the quantity of discount resources.

In some examples, during a turn-based chess game, in response to a purchase operation on a virtual chess piece, the quantity of consumed resources when the virtual chess piece is purchased is displayed; and the quantity of consumed resources corresponds to a quantity of discount resources.

For example, the set original purchase price of the virtual chess piece is 3 gold coins, a quantity of gold coins spent when the player purchases the virtual chess piece is 2, and the quantity of discount resources is 1 gold coin. To be specific, the quantity of consumed resources of the virtual chess piece is 2 gold coins, and the quantity of discount resources corresponding to the quantity of consumed resources is 1 gold coin.

In some examples, the player may purchase a virtual chess piece in a preparation stage or a battle stage in each round of the game, or the player purchases a virtual chess piece in a preparation stage or a battle stage in a previous round of the game but purchases no virtual chess piece in this round, which is not limited in this example.

In some examples, the method further includes: displaying, in response to a purchase operation on a virtual chess piece, a quantity of consumed resources when the virtual chess piece is purchased. It is displayed that the virtual chess piece is successfully purchased in a case that a quantity of inventory resources is greater than or equal to the quantity of consumed resources.

The quantity of inventory resources is configured for representing a quantity of all gold coins owned by the player. The purchase is successful in a case that the quantity of gold coins owned by the player is greater than or equal to a quantity of gold coins spent in purchasing the virtual chess piece.

In some examples, the method further includes: displaying a quantity of updated inventory resources after the virtual chess piece is successfully purchased.

In some examples, the virtual chess piece purchased by the player refers to a virtual chess piece at the basic level. In a case that a level of the virtual chess piece is determined according to a star level and a grade of the virtual chess piece, it is assumed that there are 3 star levels and 5 grades for virtual chess pieces. The virtual chess piece at the basic level is a 1-star 1/2/3/4/5-grade virtual chess piece.

Operation 540: Display, in response to a selling operation on the virtual chess piece owned, selling information of the virtual chess piece, the selling information being configured for indicating a quantity of new resources after the virtual chess piece is successfully sold, and a quantity of discount resources corresponding to the quantity of new resources being the same as the quantity of discount resources corresponding to the quantity of consumed resources.

The selling operation is an operation in which the player sells an owned virtual chess piece. The owned virtual chess piece may be a virtual chess piece at the basic level purchased from the game store or a virtual chess piece after automatic star ascension, which is not limited in this example.

The quantity of new resources is a quantity of gold coins that may be obtained when the virtual chess piece is sold. The quantity of new resources is configured for representing a selling price of the virtual chess piece.

The quantity of discount resources corresponding to the quantity of new resources refers to a quantity of gold coins discounted corresponding to the sold virtual chess piece. The quantity of discount resources is configured for representing a discounted selling price of the virtual chess piece. The discounted selling price is less than or equal to an original selling price.

The selling information refers to information displayed when the virtual chess piece is sold. The selling information is configured for indicating the quantity of new resources after the virtual chess piece is successfully sold. The selling information includes a quantity of new resources of the virtual chess piece.

In some examples, the selling information further includes a level of the virtual chess piece. The virtual chess piece at different levels corresponds to different quantities of new resources.

In some examples, displaying selling information of the virtual chess piece may be displaying a level of the virtual chess piece and a quantity of new resources corresponding to the virtual chess piece at the level.

In some examples, a quantity of discount resources corresponding to the quantity of new resources is the same as the quantity of discount resources corresponding to the quantity of consumed resources.

For example, the original purchase price of the virtual chess piece is 3 gold coins, and the original selling price is 3 gold coins. The player spends 2 gold coins in purchasing the virtual chess piece. To be specific, the quantity of consumed resources of the virtual chess piece is 2 gold coins, and the quantity of discount resources corresponding to the quantity of consumed resources is 1 gold coin. Then, when the player sells the virtual chess piece, the quantity of discount resources corresponding to the quantity of new resources is the same as the quantity of discount resources corresponding to the quantity of consumed resources. To be specific, when sold, the virtual chess piece may be required to be sold for 1 gold coin less than the original selling price, i.e., the selling price is 2 gold coins.

Operation 560: Display that the virtual chess piece is successfully sold in a case that the virtual chess piece is in a non-battle state.

The non-battle state means that the virtual chess piece is not in the battle process of this round.

For example, it is displayed that the virtual chess piece is successfully sold in a case that the virtual chess piece is in a non-battle state.

In some examples, the method further includes: displaying a quantity of updated inventory resources after the virtual chess piece is successfully sold.

Based on the above, according to the virtual chess piece selling method provided in this example of this application, the computer device does not need to store quantities of virtual resources respectively corresponding to a large number of virtual chess pieces at the time of purchase and selling. Moreover, in this example of this application, the quantities of virtual resources between purchase and selling of the virtual chess pieces are correlated. When a quantity of discount resources when a virtual chess piece is purchased is determined, a quantity of discount resources when the virtual chess piece is sold may be determined, without occupying excessive storage space of the computer device. Further, the player may also easily understand and remember quantities of gold coins when virtual chess pieces are purchased and sold, which further helps the player adjust a game strategy and improve game experience of the player.

In some examples, FIG. 7 is a flowchart of a virtual chess piece selling method according to an example of this application. Operation 540 may be implemented as operation 550 below:

Operation 550: Display a level of the virtual chess piece and a quantity of new resources corresponding to the virtual chess piece at the level; where the level is determined based on at least one type of attribute information of a star level and a grade of the virtual chess piece.

In some examples, displaying selling information of the virtual chess piece may be displaying a level of the virtual chess piece and a quantity of new resources corresponding to the virtual chess piece at the level; where the level is determined based on at least one type of attribute information of a star level and a grade of the virtual chess piece.

In some examples, the level of the virtual chess piece is determined by the star level. For example, it is assumed that there are 3 star levels and 5 grades for virtual chess pieces. A 1-star virtual chess piece is at Level 1. After star ascension, a 2-star virtual chess piece is at Level 2. After another star ascension, a 3-star virtual chess piece is at Level 3. That is, the virtual chess piece includes 3 levels, and each level further includes 5 grades.

In some other examples, the level of the virtual chess piece is determined by both the star level and the grade. For example, it is assumed that there are 3 star levels and 5 grades for virtual chess pieces. A 1-star 1/2/3/4/5-grade virtual chess piece corresponds to Level 1/2/3/4/5. After star ascension, a 2-star 1/2/3/4/5-grade virtual chess piece corresponds to Level 6/7/8/9/10. After another star ascension, a 3-star 1/2/3/4/5-grade virtual chess piece corresponds to Level 11/12/13/14/15. That is, the virtual chess piece has 15 levels.

In this example, the level of the virtual chess piece and a quantity of new resources corresponding to the virtual chess piece at the level are displayed, which can intuitively display a corresponding relationship between levels of virtual chess pieces and quantities of new resources, helping the player adjust the game strategy.

FIG. 7 is a flowchart of a virtual chess piece selling method according to an example of this application. Operation 550 may further include operation 551:

Operation 551: Display, in a case that the quantity of discount resources is zero and the level of the virtual chess piece is a basic level, the basic level of the virtual chess piece and a quantity of new resources corresponding to the virtual chess piece at the basic level; where the quantity of new resources is the same as a quantity of reference resources corresponding to the virtual chess piece at the basic level.

The levels of the virtual chess pieces include a basic level. The basic level is a level without star ascension. It is assumed that there are 3 star levels and 5 grades for virtual chess pieces. The virtual chess piece at the basic level is a 1-star 1/2/3/4/5-grade virtual chess piece.

The quantity of reference resources corresponding to the virtual chess piece at the basic level is configured for representing a set original selling price corresponding to the virtual chess piece at the basic level.

For example, the quantity of discount resources is zero, i.e., the virtual chess piece is purchased at the original purchase price at the basic level. In this case, at the basic level, a selling price of the virtual chess piece is the original selling price. To be specific, the quantity of new resources corresponding to the virtual chess piece at the basic level is the same as the quantity of reference resources corresponding to the virtual chess piece at the basic level.

For example, it is assumed that there are 3 star levels and 5 grades for virtual chess pieces. An original purchase price corresponding to the 1-star 1/2/3/4/5-grade virtual chess piece is 1/2/3/4/5 gold coins. In a case that it costs 1/2/3/4/5 gold coins to purchase the 1-star 1/2/3/4/5-grade virtual chess piece, 1/2/3/4/5 gold coins is correspondingly obtained by selling the 1-star 1/2/3/4/5-grade virtual chess piece.

In some examples, FIG. 7 is a flowchart of a virtual chess piece selling method according to an example of this application. Operation 550 may further include operation 552:

Operation 552: Display, in a case that the quantity of discount resources is zero and the level of the virtual chess piece is an enhanced level, the enhanced level of the virtual chess piece and a quantity of new resources corresponding to the virtual chess piece at the enhanced level; where the quantity of new resources is an integer multiple of the quantity of reference resources corresponding to the virtual chess piece at the basic level.

The levels of the virtual chess pieces include an enhanced level. The enhanced level is a level after star ascension. It is assumed that there are 3 star levels and 5 grades for virtual chess pieces. The virtual chess piece at the basic level is a 1-star 1/2/3/4/5-grade virtual chess piece, the virtual chess piece at the enhanced level is a 2-star 1/2/3/4/5-grade virtual chess piece or a 3-star 1/2/3/4/5-grade virtual chess piece.

For example, the quantity of discount resources is zero, i.e., the virtual chess piece is purchased at the original purchase price at the basic level. In this case, at the enhanced level, the selling price of the virtual chess piece is an integer multiple of the original selling price. To be specific, the quantity of new resources corresponding to the virtual chess piece at the enhanced level is an integer multiple of the quantity of reference resources corresponding to the virtual chess piece at the basic level.

For example, it is assumed that there are 3 star levels and 5 grades for virtual chess pieces. An original purchase price corresponding to the 1-star 1/2/3/4/5-grade virtual chess piece is 1/2/3/4/5 gold coins. In a case that it costs 1/2/3/4/5 gold coins to purchase the 1-star 1/2/3/4/5-grade virtual chess piece, 1/2/3/4/5 gold coins is correspondingly obtained by selling the 1-star 1/2/3/4/5-grade virtual chess piece. In this example, in a case that an upgrade reward mechanism is set, after star ascension, 1/2/3/4/5 gold coins is correspondingly obtained by selling the 2-star 1/2/3/4/5-grade virtual chess piece, which is 1 times the price at which the corresponding 1-star virtual chess piece is sold. After another star ascension, 3/6/9/12/15 gold coins is correspondingly obtained by selling the 3-star 1/2/3/4/5-grade virtual chess piece, which is 3 times the price at which the corresponding 1-star virtual chess piece is sold.

In some examples, FIG. 7 is a flowchart of a virtual chess piece selling method according to an example of this application. Operation 550 may further include operation 553:

Operation 553: Display, in a case that the quantity of discount resources is greater than zero and the level of the virtual chess piece is a basic level, the basic level of the virtual chess piece and a quantity of new resources corresponding to the virtual chess piece at the basic level; where the quantity of new resources is a difference between a quantity of reference resources corresponding to the virtual chess piece at the basic level and the quantity of discount resources.

For example, the quantity of discount resources is greater than zero, i.e., the virtual chess piece is purchased at a discounted purchase price less than the original purchase price at the basic level. In this case, at the basic level, a selling price of the virtual chess piece is the original selling price minus a discounted price saved. To be specific, the quantity of new resources corresponding to the virtual chess piece at the basic level is the difference between the quantity of reference resources corresponding to the virtual chess piece at the basic level and the quantity of discount resources.

For example, it is assumed that there are 3 star levels and 5 grades for virtual chess pieces. An original purchase price corresponding to a 1-star 2-grade virtual chess piece is 2 gold coins. In a case that it costs only 1 gold coin to purchase the 1-star 2-grade virtual chess piece, the 1-star 2-grade virtual chess piece sold may also be sold for 2 gold coins minus 1 gold coin. That is, the 1-star 2-grade virtual chess piece is sold only for 1 gold coin.

In some examples, FIG. 7 is a flowchart of a virtual chess piece selling method according to an example of this application. Operation 550 may further include operation 554:

Operation 554: Display, in a case that the quantity of discount resources is greater than zero and the level of the virtual chess piece is an enhanced level, the enhanced level of the virtual chess piece and a quantity of new resources corresponding to the virtual chess piece at the enhanced level; where the quantity of new resources is a difference between a quantity of reference resources corresponding to the virtual chess pieces at the enhanced level and a quantity of all discount resources saved after the virtual chess piece is obtained; and the quantity of reference resources corresponding to the virtual chess pieces at the enhanced level is an integer multiple of the quantity of reference resources corresponding to the virtual chess piece at the basic level.

In other words, the quantity of new resources is a difference between a first quantity and a second quantity, the first quantity is the quantity of reference resources corresponding to the virtual chess pieces at the enhanced level, and the second quantity is the quantity of all discount resources saved after the virtual chess piece is obtained; and the first quantity is an integer multiple of the quantity of reference resources corresponding to the virtual chess piece at the basic level.

For example, the quantity of discount resources is greater than zero, i.e., the virtual chess piece is purchased at a discounted purchase price less than the original purchase price at the basic level. In this case, at the enhanced level, the selling price of the virtual chess piece is the original selling price minus all discounted prices saved. To be specific, the quantity of new resources corresponding to the virtual chess piece at the enhanced level is a difference between a quantity of reference resources corresponding to the virtual chess pieces at the enhanced level and a quantity of all discount resources saved after the virtual chess piece is obtained.

For example, it is assumed that there are 3 star levels and 5 grades for virtual chess pieces. An original purchase price corresponding to a 1-star 2-grade virtual chess piece is 2 gold coins, and 3 1-star 2-grade virtual chess pieces may be required for star ascension. In a case that it costs only 1 gold coin to purchase the first 1-star 2-grade virtual chess piece, it costs only 1 gold coin to purchase the second 1-star 2-grade virtual chess piece, and it costs 2 gold coins to purchase the third 1-star 2-grade virtual chess piece, a total of 2 gold coins is saved. After star ascension, a 2-star 2-grade virtual chess piece may be obtained. The 2-star 2-grade virtual chess piece sold may also be sold for 2 gold coins minus 2 gold coins. That is, the 2-star 2-grade virtual chess piece is sold only for 0 gold coin.

In some examples, it is displayed that the quantity of new resources corresponding to the virtual chess piece successfully sold is greater than or equal to 0. The quantity of new resources is displayed as 0 in a case that the quantity of new resources is less than 0.

In some examples, FIG. 8 is a flowchart of a virtual chess piece selling method according to an example of this application. The method may further include the following operations:

Operation 570: Display an upgraded virtual chess piece in response to meeting an upgrade condition of the virtual chess piece.

The upgrade is a process of synthesizing N identical virtual chess pieces into a higher-level virtual chess piece when the N identical virtual chess pieces are owned in the game. N is a positive integer. The upgrade generally refers to star ascension, for example, upgrade from 1 star to 2 stars, and upgrade from 2 stars to 3 stars.

In this example, N is set to 3. The upgrade condition is to own 3 identical virtual chess pieces. “Identical virtual chess pieces” means that star levels and grades of the virtual chess pieces are identical.

In some examples, an upgraded virtual chess piece is displayed in response to meeting an upgrade condition of the virtual chess piece. The upgraded virtual chess piece means that the level of the virtual chess piece is an enhanced level.

Operation 580: Display the quantity of new resources corresponding to the upgraded virtual chess piece in a case that the virtual chess piece sold is the upgraded virtual chess piece; where the upgrade is a process of synthesizing N identical virtual chess pieces into a higher-level virtual chess piece when the N identical virtual chess pieces are owned in the game, N being a positive integer.

For example, the quantity of new resources corresponding to the upgraded virtual chess piece is displayed in a case that the virtual chess piece sold is the upgraded virtual chess piece.

In some examples, in a case that the quantity of discount resources is zero, a quantity of new resources corresponding to the upgraded virtual chess piece is displayed, i.e., the quantity of new resources corresponding to the virtual chess piece at the enhanced level is displayed; where the quantity of new resources is an integer multiple of the quantity of reference resources corresponding to the virtual chess piece at the basic level.

In some examples, in a case that the quantity of discount resources is greater than zero, a quantity of new resources corresponding to the upgraded virtual chess piece is displayed, i.e., the quantity of new resources corresponding to the virtual chess piece at the enhanced level is displayed; where the quantity of new resources is a difference between a quantity of reference resources corresponding to the virtual chess pieces at the enhanced level and a quantity of all discount resources saved after the virtual chess piece is obtained; and the quantity of reference resources corresponding to the virtual chess pieces at the enhanced level is an integer multiple of the quantity of reference resources corresponding to the virtual chess piece at the basic level.

In this example, the computer device may determine, according to the quantity of discount resources when the virtual chess piece is purchased, the quantity of discount resources when the virtual chess piece is sold. The calculation operations are simple. Moreover, the computer device does not need to store quantities of virtual resources respectively corresponding to different virtual chess pieces at the time of purchase and selling, which can effectively save storage space.

In some examples, FIG. 9 is a flowchart of a virtual chess piece selling method according to an example of this application. The method may further include the following operations:

Operation 571: Display an upgrade reward in response to meeting the upgrade condition of the virtual chess piece, the upgrade reward including one of another virtual chess piece and a virtual voucher.

In some examples, the autochess game in this example is further provided with an upgrade reward mechanism. For example, an upgrade reward is displayed in response to meeting the upgrade condition of the virtual chess piece, and the upgrade reward includes one of another virtual chess piece and a virtual voucher.

In some examples, the another virtual chess piece is a virtual chess piece randomly configured at a backend. The another virtual chess piece is a virtual chess piece matching the basic level of the virtual chess piece. The virtual voucher is a voucher matching the quantity of reference resources corresponding to the virtual chess piece at the basic level.

For example, it is assumed that there are 3 star levels and 5 grades for virtual chess pieces. A 1-star 2-grade virtual chess piece may be sold for 2 gold coins. After 3 1-star 2-grade virtual chess pieces are owned, a 2-star 2-grade virtual chess piece may be obtained by star ascension, and another 1-star 2-grade virtual chess piece or a virtual voucher is obtained.

In some examples, an upgrade reward is displayed in response to meeting the upgrade condition of the virtual chess piece, and the upgrade reward includes one of another virtual chess piece and a virtual voucher. The upgrade reward is obtained in response to a selection operation on the upgrade reward.

Operation 581: Display the quantity of reference resources corresponding to the virtual chess piece at the basic level in a case that the another virtual chess piece is sold or in a case that the virtual voucher is sold; where quantities of new resources respectively corresponding to the another virtual chess piece and the virtual voucher are both the same as the quantity of reference resources corresponding to the virtual chess piece at the basic level.

In other words, the quantity of new resources corresponding to the another virtual chess piece and the quantity of new resources corresponding to the virtual voucher are both the same as the quantity of reference resources corresponding to the virtual chess piece at the basic level.

For example, the quantities of new resources respectively corresponding to the another virtual chess piece and the virtual voucher are both the same as the quantity of reference resources corresponding to the virtual chess piece at the basic level.

For example, it is assumed that there are 3 star levels and 5 grades for virtual chess pieces. A 1-star 2-grade virtual chess piece may be sold for 2 gold coins. After 3 1-star 2-grade virtual chess pieces are owned, a 2-star 2-grade virtual chess piece may be obtained by star ascension, and another 1-star 2-grade virtual chess piece or a virtual voucher is obtained. 2 gold coins may be obtained after the virtual voucher is sold. 2 gold coins may be obtained after the another 1-star 2-grade virtual chess piece is sold.

In this example, the upgrade reward is further set while the virtual chess piece is upgraded (star ascension), enriching a human-computer interaction manner. Moreover, the upgrade reward is correlated with the virtual chess piece, and the computer device does not need to additionally store the quantity of virtual resources corresponding to the another virtual chess piece or the virtual voucher obtained by selling the upgrade reward, which can also save storage resources of the computer device to some extent.

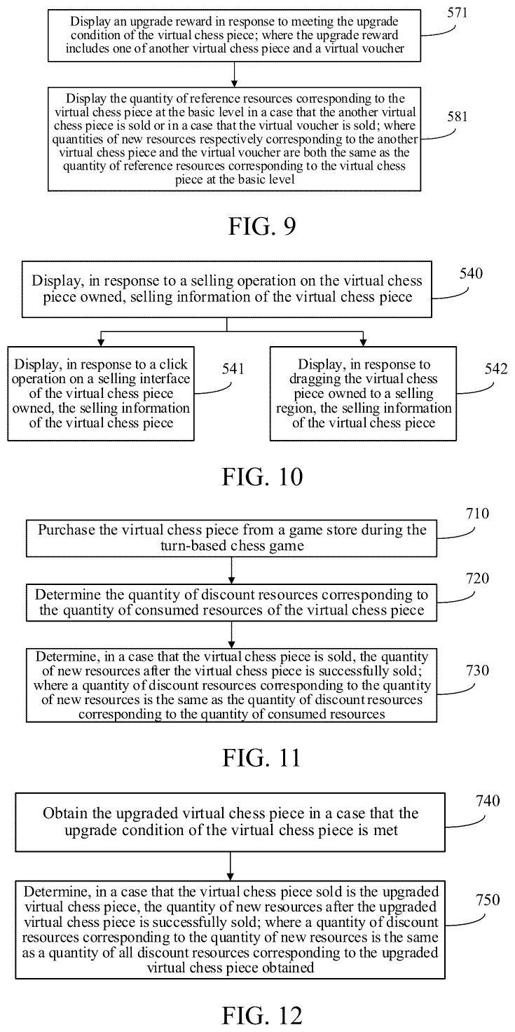

In some examples, FIG. 10 is a flowchart of a virtual chess piece selling method according to an example of this application. Operation 540 may be implemented as operation 541 or operation 542 below.

Operation 541: Display, in response to a click operation on a selling interface of the virtual chess piece owned, the selling information of the virtual chess piece.

For example, each owned virtual chess piece corresponds to a selling interface. The selling information of the virtual chess piece is displayed on the selling interface.

In some examples, the selling information of the virtual chess piece is displayed in response to a click operation on a selling interface of the virtual chess piece owned. The selling information includes a level of the virtual chess piece and a quantity of new resources corresponding to the virtual chess piece at the level.

Operation 542: Display, in response to dragging the virtual chess piece owned to a selling region, the selling information of the virtual chess piece.

For example, the game includes a selling region on the chessboard. The selling region may be set in any position region on the chessboard.

In some examples, the selling information of the virtual chess piece is displayed in response to dragging the virtual chess piece owned to a selling region. The selling information includes a quantity of new resources corresponding to the virtual chess piece.

In this example, multiple manners of displaying the selling information of the virtual chess piece by selling the virtual chess piece owned are provided, the player may choose according to an actual technical requirement, and human-computer interaction manners are relatively rich, which helps improve game experience of the player.

In some examples, FIG. 11 is a flowchart of a virtual chess piece selling method according to an example of this application. The method further includes the following operations:

Operation 710: Purchase the virtual chess piece from a game store during the turn-based chess game.

In some examples, the player may purchase the virtual chess piece from the game store during the turn-based chess game. The purchased virtual chess piece is a virtual chess piece at the basic level.

Operation 720: Determine the quantity of discount resources corresponding to the quantity of consumed resources of the virtual chess piece.

For example, the quantity of discount resources corresponding to the quantity of consumed resources of the virtual chess piece is determined, i.e., discount resources saved after the virtual chess piece is purchased are determined.

In some examples, the quantity of consumed resources of the virtual chess piece is a difference between the quantity of reference resources of the virtual chess piece and the quantity of discount resources. That is, the quantity of discount resources is a difference between the quantity of reference resources of the virtual chess piece and the quantity of consumed resources.

In some examples, different types of virtual chess pieces correspond to different quantities of discount resources, which may be determined according to actual quantities of consumed resources when the virtual chess pieces are purchased.

Operation 730: Determine, in a case that the virtual chess piece is sold, the quantity of new resources after the virtual chess piece is successfully sold; where a quantity of discount resources corresponding to the quantity of new resources is the same as the quantity of discount resources corresponding to the quantity of consumed resources.

For example, the quantity of new resources after the virtual chess piece is successfully sold is determined in a case that the virtual chess piece is sold. A quantity of discount resources corresponding to the quantity of new resources is the same as the quantity of discount resources corresponding to the quantity of consumed resources. For example, 1 gold coin is saved based on the original purchase price when the virtual chess piece is purchased. Then, when the virtual chess piece is sold, there is a need to sell the virtual chess piece for 1 gold coin less than the original selling price.

In some examples, FIG. 12 is a flowchart of a virtual chess piece selling method according to an example of this application. The method further includes the following operation:

Operation 740: Obtain the upgraded virtual chess piece in a case that the upgrade condition of the virtual chess piece is met.

The upgrade is a process of synthesizing N identical virtual chess pieces into a higher-level virtual chess piece when the N identical virtual chess pieces are owned in the game. N is a positive integer. The upgrade generally refers to star ascension, for example, upgrade from 1 star to 2 stars, and upgrade from 2 stars to 3 stars.

In this example, N is set to 3. The upgrade condition is to own 3 identical virtual chess pieces. “Identical virtual chess pieces” means that star levels and grades of the virtual chess pieces are identical.

For example, the upgraded virtual chess piece is obtained in a case that the upgrade condition of the virtual chess piece is met.

Operation 750: Determine, in a case that the virtual chess piece sold is the upgraded virtual chess piece, the quantity of new resources after the upgraded virtual chess piece is successfully sold; where a quantity of discount resources corresponding to the quantity of new resources is the same as a quantity of all discount resources corresponding to the upgraded virtual chess piece obtained.

For example, the quantity of new resources after the upgraded virtual chess piece is successfully sold is determined in a case that the virtual chess piece sold is the upgraded virtual chess piece. A quantity of discount resources corresponding to the quantity of new resources is the same as a quantity of all discount resources corresponding to the upgraded virtual chess piece obtained.

In some examples, in a case that the quantity of discount resources is zero, a quantity of new resources of the upgraded virtual chess piece is an integer multiple of the quantity of reference resources corresponding to the virtual chess piece at the basic level.

In some examples, in a case that the quantity of discount resources is greater than zero, the quantity of new resources of the upgraded virtual chess piece is a difference between a quantity of reference resources corresponding to the virtual chess pieces at the enhanced level and a quantity of all discount resources saved after the virtual chess piece is obtained; and the quantity of reference resources corresponding to the virtual chess pieces at the enhanced level is an integer multiple of the quantity of reference resources corresponding to the virtual chess piece at the basic level.

By use of the manner in the examples, the backend of the computer device can quickly determine the quantity of discount resources corresponding to the quantity of consumed resources of the virtual chess piece and determine the quantity of new resources after the virtual chess piece is successfully sold. The calculation manner is relatively simple and efficient.

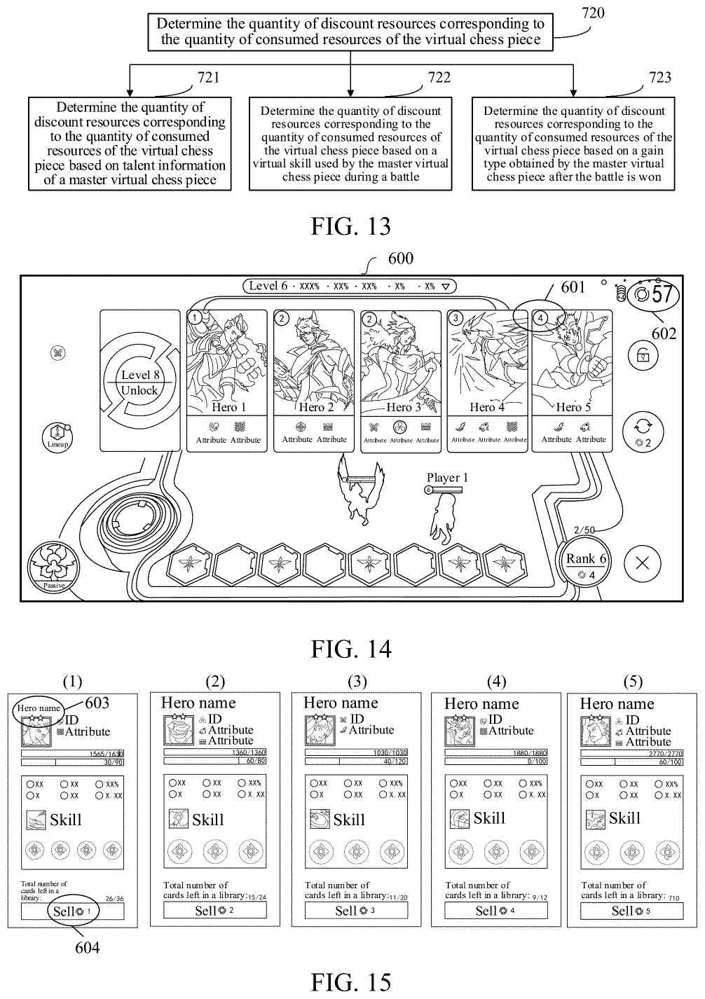

In some examples, FIG. 13 is a flowchart of a virtual chess piece selling method according to an example of this application. Operation 720 may be implemented as operation 721 or operation 722 or operation 723.

Operation 721: Determine the quantity of discount resources corresponding to the quantity of consumed resources of the virtual chess piece based on talent information of a master virtual chess piece.

The master virtual chess piece is a player character. The player may choose a character before the game starts. The talent information is one of attribute information of the master virtual chess piece. Different types of master virtual chess pieces correspond to different talent information. In some talents, the quantity of consumed resources when the virtual chess piece is purchased may be changed.

In some examples, the quantity of discount resources corresponding to the quantity of consumed resources of the virtual chess piece is determined based on talent information of a master virtual chess piece.

For example, the talent information of the master virtual chess piece is “XX discount”. The talent information mainly means that when the player purchases an owned virtual chess piece from the game store, the quantity of discount resources is 1, that is, 1 gold coin is saved.

Operation 722: Determine the quantity of discount resources corresponding to the quantity of consumed resources of the virtual chess piece based on a virtual skill used by the master virtual chess piece during a battle.

The virtual skill refers to a skill released by the master virtual chess piece during the battle.

In some examples, the quantity of discount resources corresponding to the quantity of consumed resources of the virtual chess piece is determined based on a virtual skill used by the master virtual chess piece during a battle. In some examples, the virtual chess piece at different grades corresponds to different quantities of discount resources.

For example, the virtual skill released by the master virtual chess piece during the battle is “Skill A”. According to this virtual skill, 2 opponent virtual chess pieces may be randomly copied after this round of the battle starts, and 1-star virtual chess pieces are correspondingly obtained and are placed in the battle preparation region. According to different grades of virtual chess pieces, corresponding quantities of discount resources are different. For example, quantities of discount resources respectively corresponding to 1/2/3/4/5-grade virtual chess pieces are 0/1/2/3/4.

Operation 723: Determine the quantity of discount resources corresponding to the quantity of consumed resources of the virtual chess piece based on a gain type obtained by the master virtual chess piece after the battle is won.

The gain type refers to a bonus obtained by the master virtual chess piece after the battle is won.

In some examples, the quantity of discount resources corresponding to the quantity of consumed resources of the virtual chess piece is determined based on a gain type obtained by the master virtual chess piece after the battle is won.

For example, according to “Gain type A”, the master virtual chess piece may obtain a certain quantity of “XX old coins” after the battle is won, which may be configured for purchasing a virtual chess piece corresponding to this gain type in the game store, i.e., a virtual chess piece of “Gain type A”. The quantity of “XX old coins” is a quantity of discount resources when the virtual chess piece of “Gain type A” is purchased.

In this example, the backend of the computer device may determine the quantity of discount resources of the virtual chess piece according to an actual situation of the game, which can improve accuracy of determination of the value.

Taking application to the autochess game as an example, the virtual chess piece selling method provided in this example of this application is described in detail. In this example, the virtual chess piece is a “hero”. The hero includes 3 star levels, which are 1 star, 2 stars, and 3 stars respectively. Each star level includes 5 grades, namely, 1, 2, 3, 4, and 5.

FIG. 14 is a schematic diagram of an interface for purchasing a virtual chess piece according to an example. A plurality of heroes available for the player to purchase are displayed on a display interface 600 of the game store, and quantities of consumed resources when the heroes are purchased are displayed in a display region 601. To be specific, it costs 4 gold coins to purchase Hero 5. A quantity of inventory resources of the player is displayed in a display region 602. To be specific, a quantity of gold coins owned by the player is 57. The quantity of inventory resources is greater than the quantity of consumed resources. In other words, the player can purchase Hero 5.

FIG. 15 is a schematic diagram of an interface for selling a virtual chess piece according to an example. It is assumed that it costs 1/2/3/4/5 gold coins to purchase a 1-star 1/2/3/4/5-grade hero. When sold, a 2-star 1/2/3/4/5-grade hero corresponds to a selling interface (1)/(2)/(3)/(4)/(5). On the selling interface of each hero, a star level of the hero is displayed in a display region 603, and a quantity of new resources when the hero is successfully sold is displayed in a display region 604. To be specific, a quantity of new resources corresponding to successful selling of the 2-star 1/2/3/4/5-grade hero is 1/2/3/4/5 gold coins, to be compatible with the upgrade reward mechanism set in this example.

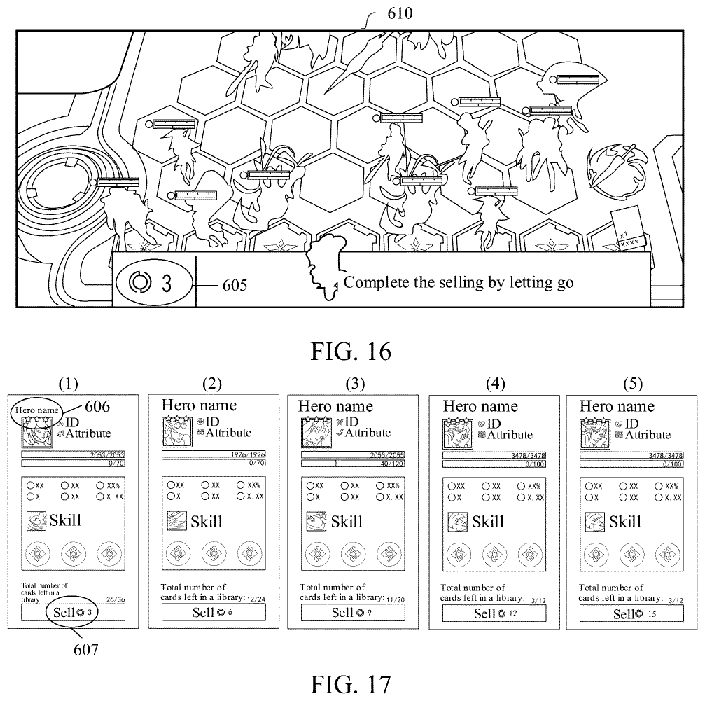

FIG. 16 is a schematic diagram of an interface for successfully selling a virtual chess piece according to an example. It is displayed in a display region 605 of a display interface 610 that 3 gold coins may be obtained when a 2-star 3-grade hero is successfully sold. The terminal responds to dragging the hero to the selling region, and the player may complete the selling by letting go.

FIG. 17 is a schematic diagram of an interface for selling a virtual chess piece according to an example. It is assumed that it costs 1/2/3/4/5 gold coins to purchase a 1-star 1/2/3/4/5-grade hero. When sold, a 3-star 1/2/3/4/5-grade hero corresponds to a selling interface (1)/(2)/(3)/(4)/(5). On the selling interface of each hero, a star level of the hero is displayed in a display region 606, and a quantity of new resources when the hero is successfully sold is displayed in a display region 607. To be specific, a quantity of new resources corresponding to successful selling of the 3-star 1/2/3/4/5-grade hero is 3/6/9/12/15 gold coins.

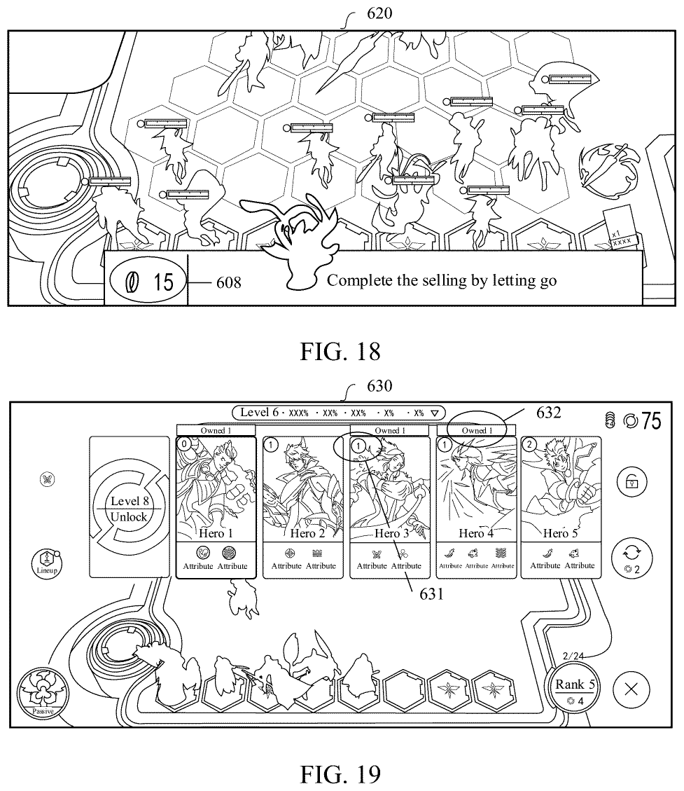

FIG. 18 is a schematic diagram of an interface for successfully selling a virtual chess piece according to an example. It is displayed in a display region 608 of a display interface 620 that 15 gold coins may be obtained when a 3-star 5-grade hero is successfully sold. The terminal responds to dragging the hero to the selling region, and the player may complete the selling by letting go.

FIG. 19 is a schematic diagram of an interface for purchasing a virtual chess piece according to an example. A plurality of heroes available for the player to purchase are displayed on a display interface 630 of the game store, and quantities of consumed resources for purchasing the heroes are displayed in a display region 631. Compared with FIG. 14, the quantities of consumed resources in this case correspond to quantities of discount resources. It is displayed in

FIG. 14 that it costs 2 gold coins to purchase a 1-star 2-grade hero 3, and it is displayed in FIG. 19 that it costs only 1 gold coin to purchase the 1-star 2-grade hero 3. That is, 1 gold coin may be saved. A quantity of this hero owned by the player at the basic level is further displayed in a display region 632. It is displayed in the display region 632 that the player owns a 1-star hero 4, which facilitates the player to adjust a purchase strategy according to the owned hero.

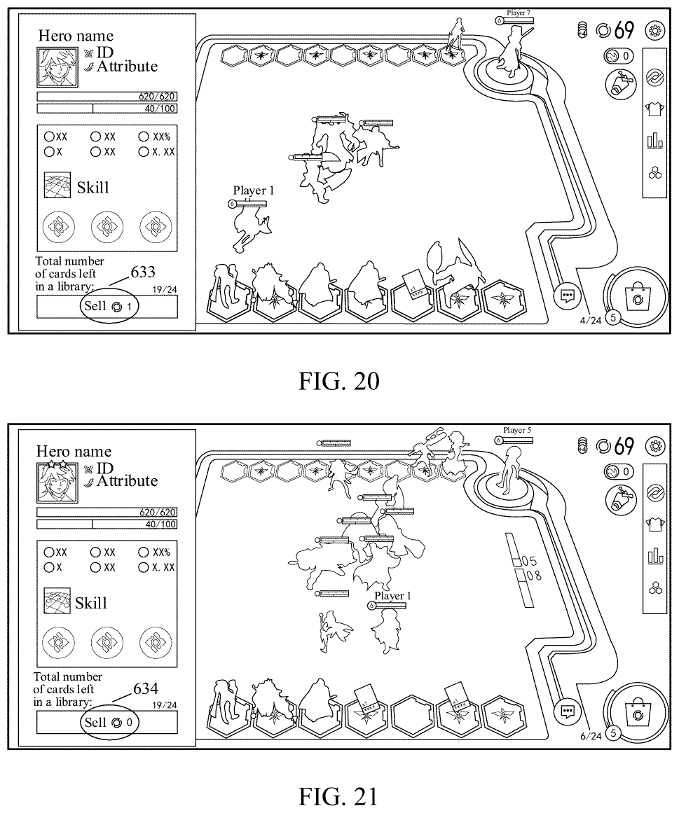

FIG. 20 is a schematic diagram of an interface for successfully selling a virtual chess piece according to an example. It is displayed in a display region 633 that 1 gold coin may be obtained when the 1-star 2-grade hero 3 purchased in FIG. 19 is successfully sold.

FIG. 21 is a schematic diagram of an interface for successfully selling a virtual chess piece according to an example. If the player purchases a first 1-star 2-grade hero 3 at the original price of 2 gold coins, purchases a second 1-star 2-grade hero 3 for 1 gold coin, and purchases a third 1-star 2-grade hero 3 for 1 gold coin again, a 2-star 2-grade hero 3 may be obtained by star ascension, and a 2-grade virtual voucher is obtained. When the 2-star 2-grade hero 3 is sold, if the discount is 2 gold coins and the original selling price is 2 gold coins, an actual selling price is 0 gold coin, which is displayed in a display region 634 in FIG. 21. The selling price of the 2-grade virtual voucher remains unchanged at 2 gold coins.

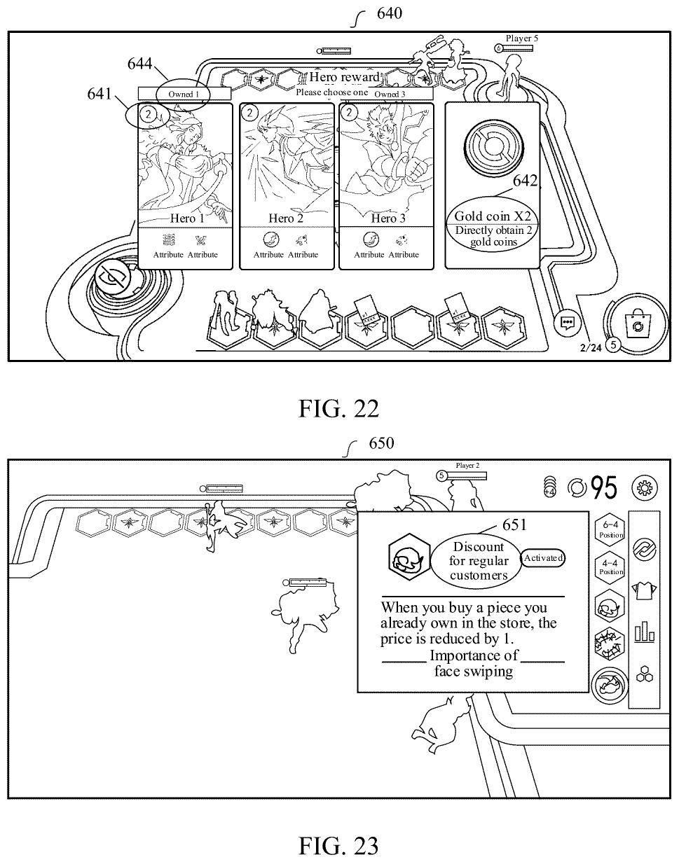

FIG. 22 is a schematic diagram of an interface for an upgrade reward according to an example. An upgrade reward mechanism is set in this example. When the 1-star 2-grade hero 3 becomes the 2-star 2-grade hero 3 by star ascension, an upgrade reward is also displayed on a display interface 640. The upgrade reward includes any N other 1-star 2-grade virtual heroes and a 2-grade virtual voucher for the player to choose one. N may be 3. An original selling price corresponding to each of the other virtual heroes is displayed in a display region 641. A quantity of such heroes at the basic level owned by the player is displayed in a display region 644. A quantity of gold coins that may be obtained by selling a virtual voucher is displayed in a display region 642. The selling price of the 2-grade virtual voucher remains unchanged at 2 gold coins.

FIG. 23 is a schematic diagram of an interface for talent information according to an example. It is displayed in a display region 651 of a display interface 650 that talent information of a master hero is “XX discount”. When the player purchases an owned hero from the game store, 1 gold coin may be saved.

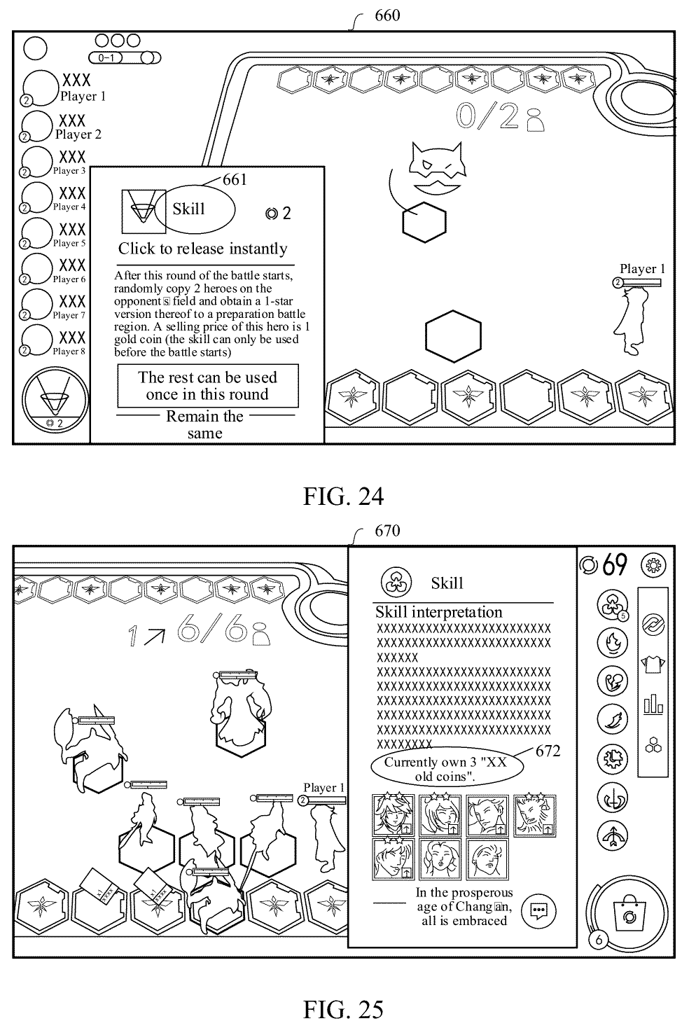

FIG. 24 is a schematic diagram of an interface for a virtual skill according to an example. A virtual skill released by the master hero during the battle is displayed in a display region 661 of a display interface 660. According to the virtual skill, 2 opponent heroes may be randomly copied after this round of the battle starts, and 1-star heroes are correspondingly obtained and are placed in the battle preparation region. A 1/2/3/4/5-grade hero corresponds to a discount of 0/1/2/3/4 gold coins respectively.

FIG. 25 is a schematic diagram of an interface for a gain type according to an example. It is displayed on a display interface 670 that according to “Gain type A”, after the battle is won, as shown by information displayed in a region 672, the master hero may obtain 3 “XX old coins”, which may be configured for purchasing a hero of “Gain type A” from the game store. The quantity of “XX old coins” is the discount.

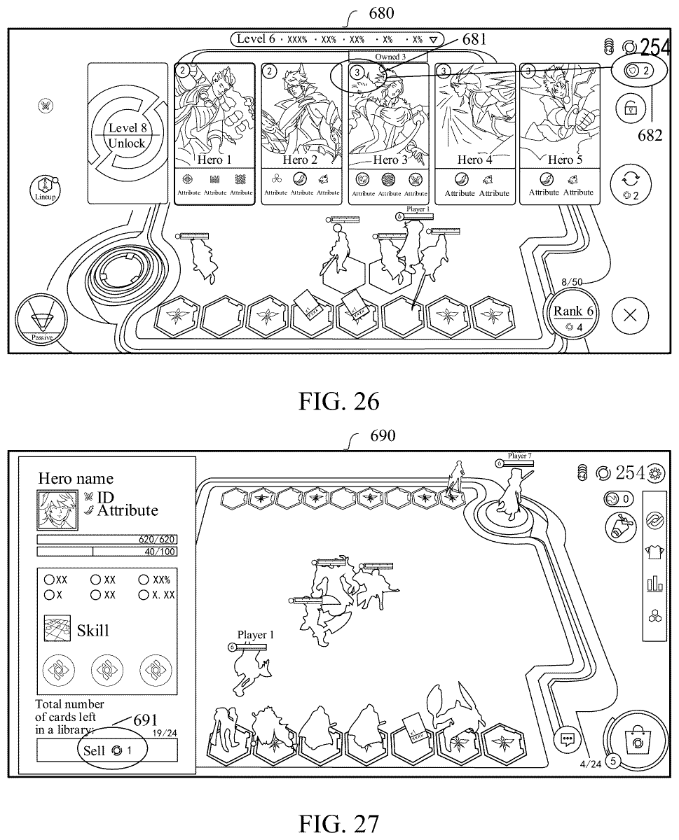

FIG. 26 is a schematic diagram of an interface for purchasing a virtual chess piece according to an example. It is displayed in a display region 681 of a display interface 680 of the game store that it costs 2 gold coins to purchase a 1-star 3-grade hero 3 of “Gain type A”. It is displayed in a display region 682 that the quantity of “XX old coins” is 2. In other words, it costs only 1 gold coin to purchase the 1-star 3-grade hero 3 of “Gain type A”.

When 3 1-star 3-grade heroes 3 of “Gain type A” whose purchase prices are 1 gold coin, 2 gold coins, and 3 gold coins respectively are synthesized into a 2-star 3-grade hero 3 of “Gain type A”, a 2-star 3-grade hero 3 of “Gain type A” and a 3-grade virtual voucher are obtained. FIG. 27 is a schematic diagram of an interface for successfully selling a virtual chess piece according to an example. It is displayed in a display region 691 of a display interface 690 that 3−2=1 gold coin may be obtained when the 2-star 3-grade hero 3 of “Gain type A” is sold.

FIG. 28 is a flowchart of a virtual chess piece selling method according to an example. For a terminal backend side, the following operations are performed:

Operation 801: Acquire a hero at a grade of N, the hero being a 1-star hero.

Operation 802: Determine whether a purchase price of the hero includes a discount; perform operation 804 in a case that the purchase price includes a discount (the purchase price is less than a set original purchase price), and perform operation 803 in a case that the purchase price includes no discount (the purchase price is equal to the set original purchase price).

Operation 803: Record the purchase price of the hero as N.

Operation 804: Record the discount of the hero as X (X is recorded as a negative value), and perform operation 805.

Operation 805: Determine whether the hero meets an upgrade condition; perform operation 807 in a case that the upgrade condition (3 identical heroes are owned) is met; and perform operation 806 in a case that the upgrade condition is not met.

Operation 806: Place the hero in a battle preparation region.

Operation 807: Acquire discounts Y and Z (Y and Z are also recorded as negative values) of the other two heroes, and perform operation 808.

Operation 808: Determine whether N+X+Y+Z is less than 0; perform operation 809 in a case that N+X+Y+Z is less than 0; and perform operation 810 in a case that N+X+Y+Z is greater than or equal to 0.

Operation 809: Determine a selling price of the upgraded hero to be 0.

Operation 810: Determine the selling price of the upgraded hero to be N+X+Y+Z.

Based on the above, according to the virtual chess piece selling method provided in this example of this application, the computer device does not need to store quantities of virtual resources respectively corresponding to a large number of virtual chess pieces at the time of purchase and selling. Moreover, the quantities of virtual resources between purchase and selling of the virtual chess pieces are correlated. When a quantity of discount resources at the time of purchase is determined, a quantity of discount resources at the time of selling may be determined, without occupying excessive storage space. Further, the player may also easily understand and remember quantities of gold coins when virtual chess pieces are purchased and sold, which further helps the player adjust a game strategy and improve game experience of the player.

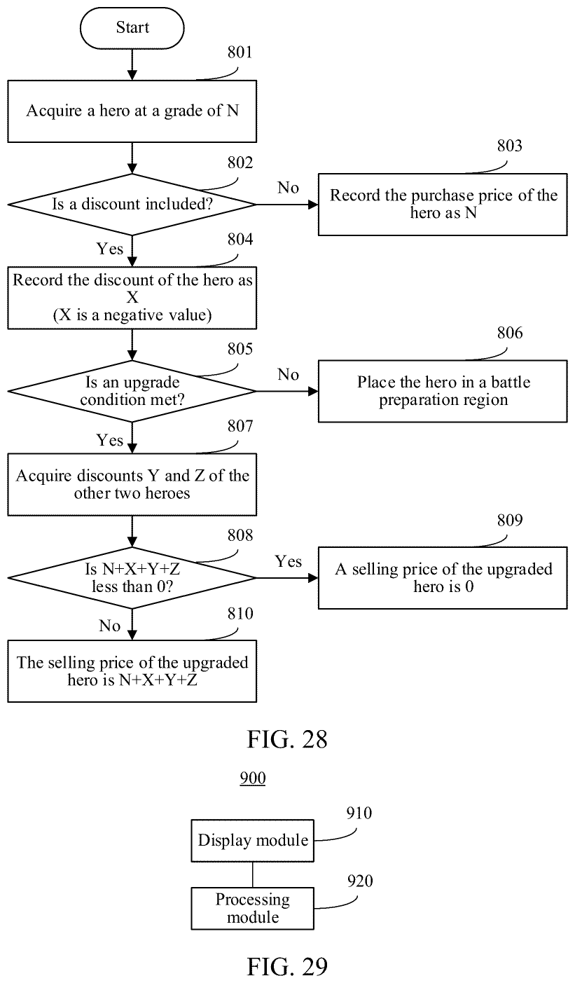

FIG. 29 is a structural block diagram of a virtual chess piece selling apparatus according to an example. The virtual chess piece selling apparatus 900 includes:
a display module 910 configured to, during a turn-based chess game, display, in response to a purchase operation on a virtual chess piece, a quantity of consumed resources when the virtual chess piece is purchased; the quantity of consumed resources corresponding to a quantity of discount resources;
the display module 910 being configured to display, in response to a selling operation on the virtual chess piece owned, selling information of the virtual chess piece, the selling information being configured for indicating a quantity of new resources after the virtual chess piece is successfully sold, and a quantity of discount resources corresponding to the quantity of new resources being the same as the quantity of discount resources corresponding to the quantity of consumed resources; and
the display module 910 being configured to display that the virtual chess piece is successfully sold in a case that the virtual chess piece is in a non-battle state.

In some examples, the display module 910 is configured to:
display a level of the virtual chess piece and a quantity of new resources corresponding to the virtual chess piece at the level;
where the level is determined based on at least one type of attribute information of a star level and a grade of the virtual chess piece.

In some examples, the display module 910 is configured to:
display, in a case that the quantity of discount resources is zero and the level of the virtual chess piece is a basic level, the basic level of the virtual chess piece and a quantity of new resources corresponding to the virtual chess piece at the basic level;
where the quantity of new resources is the same as a quantity of reference resources corresponding to the virtual chess piece at the basic level.

In some examples, the display module 910 is configured to:
display, in a case that the quantity of discount resources is zero and the level of the virtual chess piece is an enhanced level, the enhanced level of the virtual chess piece and a quantity of new resources corresponding to the virtual chess piece at the enhanced level;
where the quantity of new resources is an integer multiple of the quantity of reference resources corresponding to the virtual chess piece at the basic level.

In some examples, the display module 910 is configured to:
display, in a case that the quantity of discount resources is greater than zero and the level of the virtual chess piece is a basic level, the basic level of the virtual chess piece and a quantity of new resources corresponding to the virtual chess piece at the basic level;
where the quantity of new resources is a difference between a quantity of reference resources corresponding to the virtual chess piece at the basic level and the quantity of discount resources.

In some examples, the display module 910 is configured to:
display, in a case that the quantity of discount resources is greater than zero and the level of the virtual chess piece is an enhanced level, the enhanced level of the virtual chess piece and a quantity of new resources corresponding to the virtual chess piece at the enhanced level;
where the quantity of new resources is a difference between a quantity of reference resources corresponding to the virtual chess pieces at the enhanced level and a quantity of all discount resources saved after the virtual chess piece is obtained; and the quantity of reference resources corresponding to the virtual chess pieces at the enhanced level is an integer multiple of the quantity of reference resources corresponding to the virtual chess piece at the basic level. In other words, the quantity of new resources is a difference between a first quantity and a second quantity, the first quantity is the quantity of reference resources corresponding to the virtual chess pieces at the enhanced level, and the second quantity is the quantity of all discount resources saved after the virtual chess piece is obtained; and the first quantity is an integer multiple of the quantity of reference resources corresponding to the virtual chess piece at the basic level.

In some examples, the display module 910 is further configured to:
display an upgraded virtual chess piece in response to meeting an upgrade condition of the virtual chess piece; and
display a quantity of new resources corresponding to the upgraded virtual chess piece in a case that the virtual chess piece sold is the upgraded virtual chess piece;
where the upgrade is a process of synthesizing N identical virtual chess pieces into a higher-level virtual chess piece when the N identical virtual chess pieces are owned in the game, N being a positive integer.

In some examples, the display module 910 is further configured to:
display an upgrade reward in response to meeting the upgrade condition of the virtual chess piece, the upgrade reward including one of another virtual chess piece and a virtual voucher; and
display the quantity of reference resources corresponding to the virtual chess piece at the basic level in a case that the another virtual chess piece is sold or in a case that the virtual voucher is sold;
where quantities of new resources respectively corresponding to the another virtual chess piece and the virtual voucher are both the same as the quantity of reference resources corresponding to the virtual chess piece at the basic level. In other words, the quantity of new resources corresponding to the another virtual chess piece and the quantity of new resources corresponding to the virtual voucher are both the same as the quantity of reference resources corresponding to the virtual chess piece at the basic level.

In some examples, the display module 910 is further configured to:
display the selling information of the virtual chess piece in response to a click operation on a selling interface of the virtual chess piece owned.

In some examples, the display module 910 is further configured to:
display the selling information of the virtual chess piece in response to dragging the virtual chess piece owned to a selling region.

In some examples, the virtual chess piece selling apparatus 900 further includes a processing module 920.

In some examples, the processing module 920 is configured to:
purchase the virtual chess piece from a game store during the turn-based chess game;
determine the quantity of discount resources corresponding to the quantity of consumed resources of the virtual chess piece; and
determine, in a case that the virtual chess piece is sold, the quantity of new resources after the virtual chess piece is successfully sold;
where a quantity of discount resources corresponding to the quantity of new resources is the same as the quantity of discount resources corresponding to the quantity of consumed resources.

In some examples, the processing module 920 is configured to:
obtain the upgraded virtual chess piece in a case that the upgrade condition of the virtual chess piece is met; and
determine, in a case that the virtual chess piece sold is the upgraded virtual chess piece, the quantity of new resources after the upgraded virtual chess piece is successfully sold;
where a quantity of discount resources corresponding to the quantity of new resources is the same as a quantity of all discount resources corresponding to the upgraded virtual chess piece obtained.

In some examples, the processing module 920 is configured to:
determine the quantity of discount resources corresponding to the quantity of consumed resources of the virtual chess piece based on talent information of a master virtual chess piece.

In some examples, the processing module 920 is configured to:
determine the quantity of discount resources corresponding to the quantity of consumed resources of the virtual chess piece based on a virtual skill used by the master virtual chess piece during a battle.

In some examples, the processing module 920 is configured to:
determine the quantity of discount resources corresponding to the quantity of consumed resources of the virtual chess piece based on a gain type obtained by the master virtual chess piece after the battle is won.

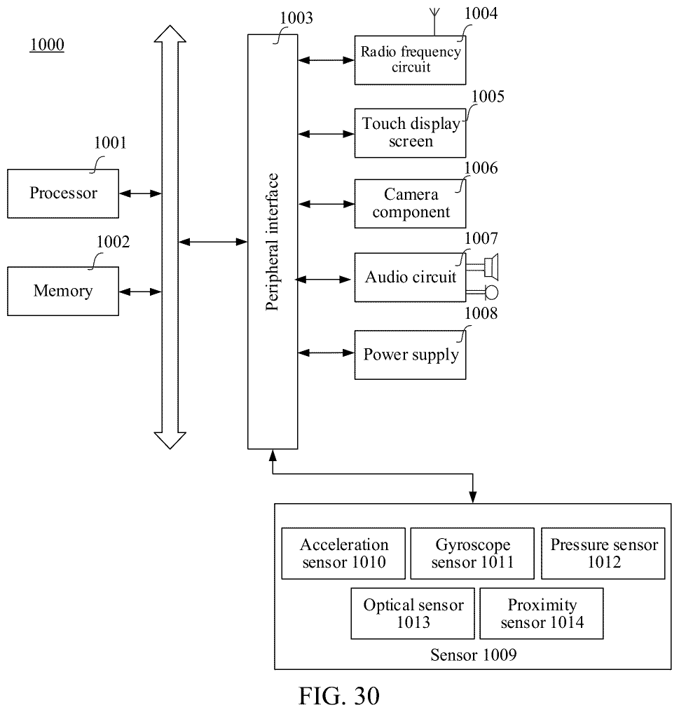

FIG. 30 is a structural block diagram of a computer device according to an example of this application.

The computer device 1000 may be a portable mobile terminal, for example, a smartphone, a tablet computer, a moving picture experts group audio layer III (MP3) player, or a moving picture experts group audio layer IV (MP4) player. The computer device 1000 may also be referred to as another name such as a user equipment or a portable terminal.

Generally, the computer device 1000 includes: a processor 1001 and a memory 1002.

The processor 1001 may include one or more processing cores, for example, a 4-core processor or an 8-core processor. The processor 1001 may be implemented in at least one hardware form of a digital signal processor (DSP), a field-programmable gate array (FPGA), and a programmable logic array (PLA). The processor 1001 may also include a main processor and a coprocessor. The main processor is a processor configured to process data in an awake state, and is also referred to as a central processing unit (CPU). The coprocessor is a low power processor configured to process data in a standby state. In some examples, the processor 1001 may be integrated with a graphics processing unit (GPU). The GPU is configured to render and draw content that needs to be displayed on a display screen. In some examples, the processor 1001 may further include an artificial intelligence (AI) processor. The AI processor is configured to process computing operations related to machine learning.

The memory 1002 may include one or more computer-readable storage media. The computer-readable storage medium may be tangible and non-transitory. The memory 1002 may further include a high-speed random access memory and a nonvolatile memory, for example, one or more disk storage devices or flash storage devices. In some examples, the non-transitory computer-readable storage medium in the memory 1002 is configured to store at least one instruction, and the at least one instruction is configured to be executed by the processor 1001 to implement the virtual chess piece selling method provided in the examples of this application.

In some examples, the computer device 1000 further includes: a peripheral interface 1003 and at least one peripheral. Specifically, the peripheral includes: at least one of a radio frequency (RF) circuit 1004, a touch display screen 1005, a camera component 1006, an audio circuit 1007, and a power supply 1008.

The peripheral interface 1003 may be configured to connect the at least one peripheral related to input/output (I/O) to the processor 1001 and the memory 1002. In some examples, the processor 1001, the memory 1002, and the peripheral interface 1003 are integrated on a same chip or circuit board. In some other examples, any one or two of the processor 1001, the memory 1002, and the peripheral interface 1003 may be implemented on a single chip or circuit board, which is not limited in this example.

The RF circuit 1004 is configured to receive and transmit an RF signal, also referred to as an electromagnetic signal. The RF circuit 1004 communicates with a communication network and other communication devices through the electromagnetic signal. The RF circuit 1004 converts an electric signal into an electromagnetic signal for transmission, or converts a received electromagnetic signal into an electric signal. In some examples, the RF circuit 1004 includes: an antenna system, an RF transceiver, one or more amplifiers, a tuner, an oscillator, a digital signal processor, a codec chip set, a subscriber identity module card, and the like. The RF circuit 1004 may communicate with another terminal by using at least one wireless communications protocol. The wireless communications protocol includes, but is not limited to, a world wide web, a metropolitan area network, an intranet, generations of mobile communication networks (2G, 3G, 4G, and 5G), a wireless local area network and/or a wireless fidelity (Wi-Fi) network. In some examples, the RF 1004 may further include a circuit related to NFC, which is not limited in this application.

The touch display screen 1005 is configured to display a user interface (UI). The UI may include a graph, text, an icon, a video, and any combination thereof. The touch display screen 1005 further has a capability of acquiring a touch signal on or above a surface of the touch display screen 1005. The touch signal may be inputted to the processor 1001 as a control signal for processing. The touch display screen 1005 is configured to provide a virtual button and/or a virtual keyboard that are/is also referred to as a soft button and/or a soft keyboard. In some examples, there may be one touch display screen 1005, disposed on a front panel of the computer device 1000. In some other examples, there may be at least two touch display screens 1005, disposed on different surfaces of the computer device 1000 respectively or in a folded design. In still other examples, the touch display screen 1005 may be a flexible display screen, disposed on a curved surface or a folded surface of the computer device 1000. Even, the touch display screen 1005 may be further set in a non-rectangular irregular pattern, namely, a special-shaped screen. The touch display screen 1005 may be prepared by using a material such as a liquid crystal display (LCD), an organic light-emitting diode (OLED), or the like.

The camera component 1006 is configured to capture images or videos. In some examples, the camera component 1006 includes a front-facing camera and a rear-facing camera. Generally, the front-facing camera is configured to implement a video call or self-portrait. The rear-facing camera is configured to shooting a picture or a video. In some examples, there are at least two rear cameras, each of which is any one of a main camera, a depth of field camera, and a wide-angle camera, so as to implement a background blurring function by fusing the main camera and the depth of field camera, and panoramic shooting and virtual reality (VR) shooting functions by fusing the main camera and the wide-angle camera. In some examples, the camera component 1006 may further include a flash. The flash may be a monochrome temperature flash, or may be a double color temperature flash. The double color temperature flash refers to a combination of a warm light flash and a cold light flash, and may be configured for light compensation under different color temperatures.

The audio circuit 1007 is configured to provide an audio interface between a user and the computer device 1000. The audio circuit 1007 may include a microphone and a speaker. The microphone is configured to acquire sound waves of the user and an environment, and convert the sound waves into an electrical signal to be inputted to the processor 1001 for processing, or to be inputted to the RF circuit 1004 for implementing voice communication. For the purpose of stereo acquisition or noise reduction, there may be a plurality of microphones, respectively disposed at different portions of the computer device 1000. The microphone may further be an array microphone or an omni-directional acquisition type microphone. The speaker is configured to convert electric signals from the processor 1001 or the RF circuit 1004 into sound waves. The speaker may be a conventional film speaker, or may be a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some examples, the audio circuit 1007 may further include an carphone jack.

The power supply 1008 is configured to supply power to components in the computer device 1000. The power supply 1008 may be an alternating current, a direct current, a disposable battery, or a rechargeable battery. When the power supply 1008 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some examples, the computer device 1000 further includes one or more sensors 1009. The one or more sensors 1009 include, but are not limited to, an acceleration sensor 1010, a gyroscope sensor 1011, a pressure sensor 1012, an optical sensor 1013, and a proximity sensor 1014.

The acceleration sensor 1010 may detect magnitude of acceleration on three coordinate axes of a coordinate system established with the computer device 1000. For example, the acceleration sensor 1010 may be configured to detect components of gravity acceleration on the three coordinate axes. The processor 1001 may control, according to a gravity acceleration signal acquired by the acceleration sensor 1010, the touch display screen 1005 to display the UI in a landscape view or a portrait view. The acceleration sensor 1010 may be further configured to acquire motion data of a game or a user.

The gyroscope sensor 1011 may detect a body direction and a rotation angle of the computer device 1000. The gyroscope sensor 1011 may cooperate with the acceleration sensor 1010 to acquire a 3D action by the user on the computer device 1000. The processor 1001 may implement the following functions according to the data acquired by the gyroscope sensor 1011: motion sensing (such as changing the UI according to a tilt operation of the user), image stabilization at shooting, game control, and inertial navigation.

The pressure sensor 1012 may be disposed at a side frame of the computer device 1000 and/or a lower layer of the touch display screen 1005. When the pressure sensor 1012 is disposed at the side frame of the computer device 1000, a holding signal of the user on the computer device 1000 may be detected, and left and right hand recognition or a quick operation may be performed according to the holding signal. When the pressure sensor 1012 is disposed on the low layer of the touch display screen 1005, an operable control on the UI may be controlled according to a pressure operation of the user on the touch display screen 1005. The operable control includes at least one of a button control, a scroll-bar control, an icon control, and a menu control.

The optical sensor 1013 is configured to acquire ambient light intensity. In an example, the processor 1001 may control the display brightness of the touch display screen 1005 according to the ambient light intensity acquired by the optical sensor 1013. Specifically, when the ambient light intensity is relatively high, the display brightness of the touch display screen 1005 is increased. When the ambient light intensity is relatively low, the display brightness of the touch display screen 1005 is decreased. In another example, the processor 1001 may further dynamically adjust a camera parameter of the camera component 1006 according to the ambient light intensity acquired by the optical sensor 1013.

The proximity sensor 1014, also referred to as a distance sensor, is generally disposed on the front surface of the computer device 1000. The proximity sensor 1014 is configured to acquire a distance between the user and the front surface of the computer device 1000. In an example, when the proximity sensor 1014 detects that the distance between the user and the front surface of the computer device 1000 gradually increases, the processor 1001 is controlled by the touch display screen 1005 to switch from a screen-off state to a screen-on state. When the proximity sensor 1014 detects that the distance between the user and the front surface of the computer device 1000 gradually increases, the touch display screen 1005 is controlled by the processor 1001 to switch from the screen-off state to the screen-on state.

A person skilled in the art may understand that the structure shown in FIG. 30 constitutes no limitation on the computer device 1000, and the terminal may include more or fewer components than those shown in the figure, or some components may be combined, or a different component deployment may be used.

An example of this application further provides a chip. The chip includes at least one of a programmable logic circuit and/or program instructions. When running on the computer device, the chip is configured to implement the virtual chess piece selling method as provided in the method examples.

An example of this application provides a non-transitory computer-readable storage medium. The computer-readable storage medium stores a computer program, and the computer program is loaded and executed by a processor to implement the virtual chess piece selling method as provided in the method examples.

An example of this application provides a computer program product or a computer program. The computer program product or the computer program includes computer instructions. The computer instructions are stored in a computer-readable storage medium. A processor of a computer device reads the computer instructions from the computer-readable storage medium, causing the processor to load and execute the computer instructions to implement the virtual chess piece selling method as provided in the method examples.

The sequence numbers of the foregoing examples of this application are merely for description purpose but do not imply the preference among the examples.

A person of ordinary skill in the art may understand that all or some of the operations of the foregoing examples may be implemented by hardware, or may be implemented by a program instructing relevant hardware. The program may be stored in a computer-readable storage medium. The storage medium may be a read-only memory, a magnetic disk, an optical disc, or the like.

A person skilled in the art should be aware that in the foregoing one or more examples, functions described in the examples of this application may be implemented by hardware, software, firmware, or any combination thereof. When implemented by using software, the functions may be stored in a computer-readable medium or may be used as one or more instructions or code in a computer-readable medium for transmission. The computer-readable medium includes a computer storage medium and a communication medium. The communication medium includes any medium that enables a computer program to be transmitted from one place to another. The storage medium may be any available medium accessible to a general-purpose or special-purpose computer.

What is claimed is:

1. A virtual chess piece selling method, performed by a computing device and comprising:
during a turn-based chess game, displaying, in response to a purchase operation on a virtual chess piece, a quantity of consumed resources based on the virtual chess piece being purchased, the quantity of consumed resources corresponding to a quantity of discount resources;
displaying, in response to a selling operation on the virtual chess piece, selling information of the virtual chess piece, the selling information indicating a quantity of new resources based on the virtual chess piece being successfully sold, and a quantity of discount resources corresponding to the quantity of new resources being the same as the quantity of discount resources corresponding to the quantity of consumed resources; and
displaying that the virtual chess piece is successfully sold based on the virtual chess piece being in a non-battle state.

2. The method according to claim 1, wherein the displaying the selling information of the virtual chess piece comprises:
displaying a level of the virtual chess piece and a quantity of new resources corresponding to the virtual chess piece at the level;
wherein the level is determined based on at least one of attribute information of a star level and a grade of the virtual chess piece.

3. The method according to claim 2, wherein the displaying the level of the virtual chess piece and the quantity of new resources corresponding to the virtual chess piece at the level comprises:
displaying, based on the quantity of discount resources being zero and the level of the virtual chess piece being a basic level, the basic level of the virtual chess piece and a quantity of new resources corresponding to the virtual chess piece at the basic level;
wherein the quantity of new resources corresponding to the virtual chess piece at the basic level is the same as a quantity of reference resources corresponding to the virtual chess piece at the basic level.

4. The method according to claim 2, wherein the displaying the level of the virtual chess piece and the quantity of new resources corresponding to the virtual chess piece at the level comprises:
displaying, based on the quantity of discount resources being zero and the level of the virtual chess piece being an enhanced level, the enhanced level of the virtual chess piece and a quantity of new resources corresponding to the virtual chess piece at the enhanced level;
wherein the quantity of new resources corresponding to the virtual chess piece at the enhanced level is an integer multiple of a quantity of reference resources corresponding to the virtual chess piece at a basic level.

5. The method according to claim 2, wherein the displaying the level of the virtual chess piece and the quantity of new resources corresponding to the virtual chess piece at the level comprises:
displaying, based on the quantity of discount resources being greater than zero and the level of the virtual chess piece being a basic level, the basic level of the virtual chess piece and a quantity of new resources corresponding to the virtual chess piece at the basic level;
wherein the quantity of new resources corresponding to the virtual chess piece at the basic level is a difference between a quantity of reference resources corresponding to the virtual chess piece at the basic level and the quantity of discount resources.

6. The method according to claim 2, wherein the displaying the level of the virtual chess piece and the quantity of new resources corresponding to the virtual chess piece at the level comprises:
displaying, based on the quantity of discount resources being greater than zero and the level of the virtual chess piece being an enhanced level, the enhanced level of the virtual chess piece and a quantity of new resources corresponding to the virtual chess piece at the enhanced level;
wherein the quantity of new resources corresponding to the virtual chess piece at the enhanced level is a difference between a first quantity and a second quantity, the first quantity is a quantity of reference resources corresponding to the virtual chess pieces at the enhanced level, and the second quantity is a quantity of all discount resources saved after the virtual chess piece is obtained, and the first quantity is an integer multiple of a quantity of reference resources corresponding to the virtual chess piece at a basic level.

7. The method according to claim 4, further comprising:
displaying an upgraded virtual chess piece in response to meeting an upgrade condition of the virtual chess piece; and
displaying a quantity of new resources corresponding to the upgraded virtual chess piece based on the virtual chess piece sold being the upgraded virtual chess piece;
wherein the upgrade is a process of synthesizing N identical virtual chess pieces into a higher-level virtual chess piece based on the N identical virtual chess pieces being owned in the game, N being a positive integer.

8. The method according to claim 7, further comprising:
displaying an upgrade reward in response to meeting the upgrade condition of the virtual chess piece, the upgrade reward comprising one of another virtual chess piece and a virtual voucher; and
displaying the quantity of reference resources corresponding to the virtual chess piece at the basic level based on the other virtual chess piece being sold or the virtual voucher being sold;
wherein a quantity of new resources corresponding to the other virtual chess piece and a quantity of new resources corresponding to the virtual voucher are both the same as the quantity of reference resources corresponding to the virtual chess piece at the basic level.

9. The method according to claim 1, wherein the displaying, in response to the selling operation on the virtual chess piece, the selling information of the virtual chess piece comprises:
displaying, in response to a click operation on a selling interface of the virtual chess piece, the selling information of the virtual chess piece;
or
displaying, in response to dragging the virtual chess piece to a selling region, the selling information of the virtual chess piece.

10. The method according to claim 1, further comprising:
purchasing the virtual chess piece from a game store during the turn-based chess game;
determining the quantity of discount resources corresponding to the quantity of consumed resources of the virtual chess piece; and
determining, based on the virtual chess piece being sold, the quantity of new resources based on the virtual chess piece being successfully sold;
wherein the quantity of discount resources corresponding to the quantity of new resources is the same as the quantity of discount resources corresponding to the quantity of consumed resources.

11. The method according to claim 10, further comprising:
obtaining an upgraded virtual chess piece based on an upgrade condition of the virtual chess piece being met; and
determining, based on the virtual chess piece sold being the upgraded virtual chess piece, the quantity of new resources based on the upgraded virtual chess piece being successfully sold;
wherein the quantity of discount resources corresponding to the quantity of new resources is the same as a quantity of all discount resources corresponding to the upgraded virtual chess piece.

12. The method according to claim 10, further comprising:
determining the quantity of discount resources corresponding to the quantity of consumed resources of the virtual chess piece based on talent information of a master virtual chess piece;
or
determining the quantity of discount resources corresponding to the quantity of consumed resources of the virtual chess piece based on a virtual skill used by the master virtual chess piece during a battle;
or
determining the quantity of discount resources corresponding to the quantity of consumed resources of the virtual chess piece based on a gain type obtained by the master virtual chess piece after the battle is won.

13. A virtual chess piece selling apparatus, comprising:
one or more processors; and
memory storing instructions that, when executed by the one or more processors, cause the virtual chess piece selling apparatus to:
during a turn-based chess game, display, in response to a purchase operation on a virtual chess piece, a quantity of consumed resources based on the virtual chess piece being purchased, the quantity of consumed resources corresponding to a quantity of discount resources;
display, in response to a selling operation on the virtual chess piece, selling information of the virtual chess piece, the selling information indicating a quantity of new resources based on the virtual chess piece being successfully sold, and a quantity of discount resources corresponding to the quantity of new resources being the same as the quantity of discount resources corresponding to the quantity of consumed resources; and
display that the virtual chess piece is successfully sold based on the virtual chess piece being in a non-battle state.

14. The apparatus according to claim 13, wherein the instructions, when executed by the one or more processors, cause the virtual chess piece selling apparatus to:
display a level of the virtual chess piece and a quantity of new resources corresponding to the virtual chess piece at the level;
wherein the level is determined based on at least one of attribute information of a star level and a grade of the virtual chess piece.

15. The apparatus according to claim 14, wherein the instructions, when executed by the one or more processors, cause the virtual chess piece selling apparatus to:
display, based on the quantity of discount resources being zero and the level of the virtual chess piece being a basic level, the basic level of the virtual chess piece and a quantity of new resources corresponding to the virtual chess piece at the basic level;
wherein the quantity of new resources corresponding to the virtual chess piece at the basic level is the same as a quantity of reference resources corresponding to the virtual chess piece at the basic level.

16. The apparatus according to claim 14, wherein the instructions, when executed by the one or more processors, cause the virtual chess piece selling apparatus to:
display, based on the quantity of discount resources being zero and the level of the virtual chess piece being an enhanced level, the enhanced level of the virtual chess piece and a quantity of new resources corresponding to the virtual chess piece at the enhanced level;
wherein the quantity of new resources corresponding to the virtual chess piece at the enhanced level is an integer multiple of a quantity of reference resources corresponding to the virtual chess piece at a basic level.

17. The apparatus according to claim 14, wherein the instructions, when executed by the one or more processors, cause the virtual chess piece selling apparatus to:
display, based on the quantity of discount resources being greater than zero and the level of the virtual chess piece being a basic level, the basic level of the virtual chess piece and a quantity of new resources corresponding to the virtual chess piece at the basic level;
wherein the quantity of new resources corresponding to the virtual chess piece at the basic level is a difference between a quantity of reference resources corresponding to the virtual chess piece at the basic level and the quantity of discount resources.

18. A non-transitory computer-readable storage medium, when executed, cause:
during a turn-based chess game, displaying, in response to a purchase operation on a virtual chess piece, a quantity of consumed resources based on the virtual chess piece being purchased, the quantity of consumed resources corresponding to a quantity of discount resources;
displaying, in response to a selling operation on the virtual chess piece, selling information of the virtual chess piece, the selling information indicating a quantity of new resources based on the virtual chess piece being successfully sold, and a quantity of discount resources corresponding to the quantity of new resources being the same as the quantity of discount resources corresponding to the quantity of consumed resources; and
displaying that the virtual chess piece is successfully sold based on the virtual chess piece being in a non-battle state.

19. The non-transitory computer-readable storage medium of claim 18, when executed, cause:
displaying a level of the virtual chess piece and a quantity of new resources corresponding to the virtual chess piece at the level;
wherein the level is determined based on at least one of attribute information of a star level and a grade of the virtual chess piece.

20. The non-transitory computer-readable storage medium of claim 19, when executed, cause:
displaying, based on the quantity of discount resources being zero and the level of the virtual chess piece being a basic level, the basic level of the virtual chess piece and a quantity of new resources corresponding to the virtual chess piece at the basic level;
wherein the quantity of new resources corresponding to the virtual chess piece at the basic level is the same as a quantity of reference resources corresponding to the virtual chess piece at the basic level.
